(19) United States
(12) Patent Application Publication
(10) Pub. No.: US 2014/0120961 A1
(43) Pub. Date: May 1, 2014

(54) SYSTEM AND METHOD FOR SECURE MESSAGE COMPOSITION OF SECURITY MESSAGES

(71) Applicant: LOOKOUT, INC., San Francisco, CA (US)

(72) Inventor: Brian James BUCK, Livermore, CA (US)

(73) Assignee: LOOKOUT, INC., San Francisco, CA (US)

(21) Appl. No.: 13/729,793

(22) Filed: Dec. 28, 2012

Related U.S. Application Data
(63) Continuation-in-part of application No. 13/686,028, filed on Nov. 27, 2012, now Pat. No. 8,655,307.
(60) Provisional application No. 61/719,233, filed on Oct. 26, 2012.

(51) Int. Cl. H04W 4/12; H04W 4/14

(52) U.S. Cl. CPC H04W 4/12; H04W 4/14
USPC 455/466

(57) ABSTRACT

Systems and methods are provided for secure composition of security messages. A text message template may be displayed on a display of a mobile communications device. The text message template may include a first text field associated with a semantic category representing a plurality of items identified based on their meaning. At least one button associated with the semantic category may be presented on the display of the mobile communications device. An input may be received at the at least one button from a user of the mobile communications device. At least some of the plurality of items belonging to the semantic category associated with the first text field may be presented on the display of the mobile communications device. A selection of an item of the plurality of items may be received. The selected item may be presented in the first text field of the text message template.

### CROSS-REFERENCE TO RELATED APPLICATIONS

This patent application is a continuation-in-part (CIP) of U.S. patent application Ser. No. 13/686,028, filed on Nov. 27, 2012, which claims priority to U.S. provisional patent application 61/719,233, filed on Oct. 26, 2012, which are incorporated by reference along with all other references cited in this application.

### BACKGROUND

Users of mobile devices or mobile communications devices employ text messaging applications to inform others of their status, intentions, travel, sentiments, and other topics. Text entry on mobile devices (such as smart phones) can be difficult, slow, and error-prone. Errors in typing can lead to misunderstandings by the message recipient. Errors in typing, when “corrected” by automatic means, can lead to incorrect or even embarrassing changes to the content and intent of the user sending the message. Conventional methods remain limited in that they do not provide users with a fast method for message composition that securely ensures that the message intent will not be corrupted either by the user's typing errors or by automatic corrections provided by messaging applications to user typing errors. More specifically, messages may relate to the security and safety of the user, the user's device, or activities that occurred on the mobile device. Thus, it is important to facilitate rapid and accurate composition of such messages.

### BRIEF SUMMARY OF THE INVENTION

In some embodiments, systems and methods are provided for generating text messages based on previously sent text messages, measurements, characteristics, and past and current usage histories of device applications, sensors, communication mechanisms, component usage, available power sources, or current and anticipated locations. A plurality of text message templates may be generated that provide for the automatic inclusion of information that may be difficult to type or maybe particularly error-prone when performed by a user. The information may include, be modified by, or be arranged by, context information associated with the user. Thus, each text message template may include one or more text fields that may be populated with information based on, among other things, input received from a user and context information relevant to the user's and the mobile communications device's context.

In various embodiments, a method of generating a text message on a mobile communications device is provided. The method may include presenting a text message template on a display of a mobile communications device, where the text message template includes a first text field associated with a semantic category representing a plurality of items identified based, at least in part, on their meaning. The method may further include presenting, on the display of the mobile communications device, at least one button associated with the semantic category. The method may also include receiving, at the at least one button, an input from a user of the mobile communications device. The method may further include presenting, on the display of the mobile communications device, at least some of the plurality of items belonging to the semantic category associated with the first text field, the presenting being responsive to receiving the input. The method may also include receiving a selection of an item of the plurality of items, and presenting, at the display of the mobile communications device, the selected item in the first text field of the text message template.

In some embodiments, the method may further comprise collecting, on the mobile communications device, context information describing a plurality of activities associated with usage of the mobile communications device. In various embodiments, the context information is a type of information selected from the group consisting of: a geographical location associated with the user, applications used by the user, time and date information, and a speed associated with the user. The method may further include selecting the text message template based on the context information and identifying the at least some of the plurality of items based on the context information. In some embodiments, the plurality of items is presented in an order determined based on the context information. In various embodiments, the semantic category is selected from the group consisting of: status, location, date, time, and security. The text message template may be generated by one or more components of the mobile communications device based on a plurality of text messages previously sent by the user. The text message template may further include a second text field that is automatically populated by one or more components of the mobile communications device. In some embodiments, the second text field is automatically populated based on the received selection of the item. The text message template may be a template for a short message service (SMS) message. The text message template may relate to a security event on the mobile communications device.

In some embodiments, a method of generating a text message on a mobile communications device is provided. The method may include retrieving context information from a plurality of applications running on the mobile communications device, where the context information describes a plurality of activities associated with usage of the mobile communications device. The method may also include processing the context information by grouping the context information into a plurality of semantic categories each representing a plurality of items identified based, at least in part, on their meaning. The method may further include generating a text message based on the context information and a text message template, where the text message template includes a plurality of text fields, each text field of the plurality of text fields being associated with a semantic category of the plurality of semantic categories.

In some embodiments, the context information may be grouped into the plurality of semantic categories based on an ontological semantic analysis of the information retrieved from the plurality of applications running on the mobile communications device. The semantic category may be selected from the group consisting of: status, location, date, time, and security. The context information may be a type of information selected from the group consisting of: a geographical location associated with the user, applications used by the user, time and date information, and a speed associated with the user.

In various embodiments, a method of generating a text message on a mobile communications device is provided. The method may include retrieving context information from a plurality of applications running on the mobile communications device, where the context information describes a plurality of activities associated with usage of the mobile communications device. The method may further include processing the context information to group the context information according to a plurality of semantic categories each representing a plurality of items identified based, at least in part, on their meaning. The method may also include providing context information associated with a semantic category of the plurality of semantic categories to a text message template generator, where the text message template generator is an application running on the mobile communications device and is configured to generate a text message based on the context information and a text message template. The text message template may include a plurality of text fields, each text field of the plurality of text fields being associated with a semantic category of the plurality of semantic categories.

In some embodiments, the context information may be grouped into the plurality of semantic categories based on an ontological semantic analysis of the information retrieved from the plurality of applications running on the mobile communications device. The processing may be performed by a context management service that is an application registered with an operating system of the mobile communications device as a semantic content provider. The context information may be provided in response to a request issued by the text message template generator. The context information may be a type of information selected from the group consisting of: a geographical location associated with the user, applications used by the user, time and date information, and a speed associated with the user.

### BRIEF DESCRIPTION OF THE DRAWINGS

The present invention is illustrated by way of example and not limitation in the figures of the accompanying drawings, in which like references indicate similar elements, and in which:

FIG. 1 shows a simplified block diagram of a specific embodiment of a system for managing mobile device resources implemented in a distributed computing network connecting a server and clients.

FIG. 2 shows a more detailed diagram of an exemplary client of the mobile device resource management system.

FIG. 3 shows a block diagram of a user interacting with a mobile device having a resource manager of a resource prediction system.

FIG. 4 shows a block diagram of the resource prediction system and its subsystems.

FIG. 5 shows a more detailed block diagram of the resource prediction system shown in FIG. 4.

FIG. 6 shows a block diagram of a mobile device and a management service running on a server or in the cloud.

FIG. 7 shows a block diagram of a mobile device with a management service running on the mobile device.

FIG. 8 shows a block diagram of the Activity Store and its components.

FIG. 9 shows a block diagram of the Active State component.

FIG. 10 shows a block diagram of a mobile device and a context management service running on a server or in the cloud.

FIG. 11 shows a block diagram of a mobile device with a context management service running on the mobile device.

FIG. 12 shows a block diagram of a system that includes a mobile device, where the mobile device includes a text message template generator and a context management service.

FIG. 13 shows a block diagram of the Context Ontology with Resource and Policy Semantics repository (CORPS).

FIG. 14 shows a block diagram of the Context History Store.

FIG. 15 shows a block diagram of the Active Context component.

FIG. 16 shows an example diagram of a fuzzy set membership function.

FIG. 17 shows a diagram of a Context Behavior Resource Glide Path.

FIG. 18 shows an example of an ontology.

FIG. 19 shows an overall flow for resource predictions.

FIG. 20 illustrates an example of a method for generating a text message, in accordance with some embodiments.

FIG. 21 illustrates an example of a method for generating a text message in which a text message template generator and a context management service are included in the same application on a mobile device, in accordance with some embodiments.

FIG. 22 illustrates an example of a method for generating a text message in which a text message template generator and a context management service are included in different applications on a mobile device, in accordance with some embodiments.

FIG. 23 shows an example of an image of a user interface that may be used to compose text messages, in accordance with some embodiments.

FIG. 24 shows an example of an image of a user interface presenting several text message templates to a user at a display of a mobile device, in accordance with some embodiments.

FIG. 25 shows an example of an image of a user interface presenting several items belonging to a semantic category at a display of a mobile device, in accordance with some embodiments.

FIG. 26 shows an example of an image of a user interface in which a second iteration of a text message generation method is being performed, in accordance with some embodiments.

FIG. 27 shows an example of an image of a user interface in which a second text message template has been chosen and a first content button has been selected for a first text field, in accordance with some embodiments.

FIG. 28 shows an example of an image of a user interface in which a second content button has been selected for a second text field, in accordance with some embodiments.

FIG. 29 shows an example of an image of a user interface in which a text entry window includes multiple text message templates that have been generated and completed, in accordance with some embodiments.

### DETAILED DESCRIPTION

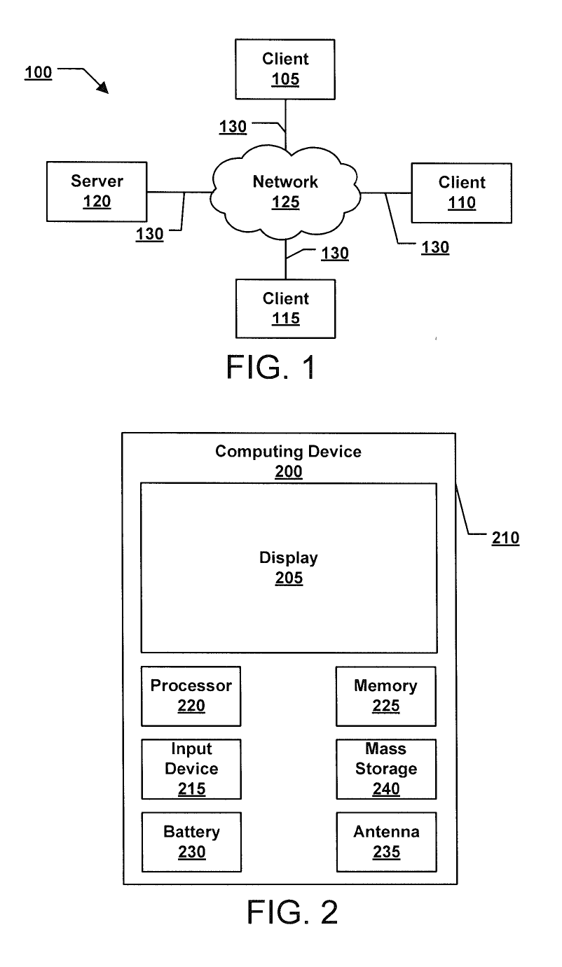

FIG. 1 is a simplified block diagram of a distributed computer network 100 incorporating a specific embodiment of a system for managing resource usage on a mobile device. Computer network 100 includes a number of client systems 105, 110, and 115, and a server system 120 coupled to a communication network 125 via a plurality of communication links 130. Communication network 125 provides a mechanism for allowing the various components of distributed network 100 to communicate and exchange information with each other.

Communication network 125 may itself be comprised of many interconnected computer systems and communication links. Communication links 130 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, Internet telephony, IP telephony, digital voice, voice over broadband (VoBB), broadband telephony, Voice over IP (VoIP), public switched telephone network (PSTN), and others. While in one embodiment, communication network 125 is the Internet, in other embodiments, communication network 125 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment and does not limit the scope of the systems and methods as recited in the claims. One of ordinary skill in the art would recognize other variations, modifications, and alternatives. For example, more than one server system 120 may be connected to communication network 125. As another example, a number of client systems 105, 110, and 115 may be coupled to communication network 125 via an access provider (not shown) or via some other server system.

Client systems 105, 110, and 115 typically request information from a server system which provides the information. Server systems by definition typically have more computing and storage capacity than client systems. However, a particular computer system may act as both a client or a server depending on whether the computer system is requesting or providing information. Aspects of the system may be embodied using a client-server environment or a cloud-cloud computing environment.

Server 120 is responsible for receiving information requests from client systems 105, 110, and 115, performing processing required to satisfy the requests, and for forwarding the results corresponding to the requests back to the requesting client system. The processing required to satisfy the request may be performed by server system 120 or may alternatively be delegated to other servers connected to communication network 125.

Client systems 105, 110, and 115 enable users to access and query information or applications stored by server system 120. Some example client systems include desktop computers, portable electronic devices (e.g., mobile communication devices, smartphones, tablet computers, laptops) such as the Samsung Galaxy Tab®, Google Nexus devices, Amazon Kindle®, Kindle Fire®, Apple iPhone®, the Apple iPad®, Microsoft Surface®, the Palm Pre™, or any device running the Apple iOS™ Android™ OS, Google Chrome OS, Symbian OS®, Windows Mobile® OS, Windows Phone, BlackBerry OS, Embedded Linux, webOS, Palm OS® or Palm Web OS™.

In a specific embodiment, a “web browser” application executing on a client system enables users to select, access, retrieve, or query information and/or applications stored by server system 120. Examples of web browsers include the Android browser provided by Google, the Safari® browser provided by Apple, Amazon Silk® provided by Amazon, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others (e.g., Google Chrome).

FIG. 2 shows an exemplary computer system such as a client system. In an embodiment, a user interfaces with the system through a client system, such as shown in FIG. 2. Mobile client communication or portable electronic device 200 includes a display, screen, or monitor 205, housing 210, and input device 215. Housing 210 houses familiar computer components, some of which are not shown, such as a processor 220, memory 225, battery 230, speaker, transceiver, antenna 235, microphone, ports, jacks, connectors, camera, input/output (I/O) controller, display adapter, network interface, mass storage devices 240, and the like.

Input device 215 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, or combinations of these.

Mass storage devices 240 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

The system may also be used with computer systems having different configurations, e.g., with additional or fewer subsystems. For example, a computer system could include more than one processor (i.e., a multiprocessor system, which may permit parallel processing of information) or a system may include a cache memory. The computer system shown in FIG. 2 is but an example of a computer system suitable for use. Other configurations of subsystems suitable for use will be readily apparent to one of ordinary skill in the art. For example, in a specific implementation, the computing device is mobile communication device such as a smartphone or tablet computer. Some specific examples of smartphones include the Droid Incredible and Google Nexus One, provided by HTC Corporation, the iPhone or iPad, both provided by Apple, and many others. The computing device may be a laptop or a netbook. In another specific implementation, the computing device is a non-portable computing device such as a desktop computer or workstation.

A computer-implemented or computer-executable version of the program instructions useful to practice the systems and techniques described in this application may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the techniques described in this application may be stored or reside in RAM or cache memory, or on mass storage device 240. The source code of this software may also be stored or reside on mass storage device 240 (e.g., flash drive, hard disk, magnetic disk, tape, or CD-ROM). As a further example, code useful for practicing the techniques described in this application may be transmitted via wires, radio waves, or through a network such as the Internet. In another specific embodiment, a computer program product including a variety of software program code to implement features described in this application is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Windows Phone, Symbian, BlackBerry OS, Palm web OS, bada, Embedded Linux, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 7, Windows 8, Windows CE, Windows Mobile, Windows Phone 7), Linux, HP-UX, UNIX, Sun OS, Solaris, Mac OS X, Alpha OS, AIX, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system useful in practicing the systems and methods in this application using a wireless network employing a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

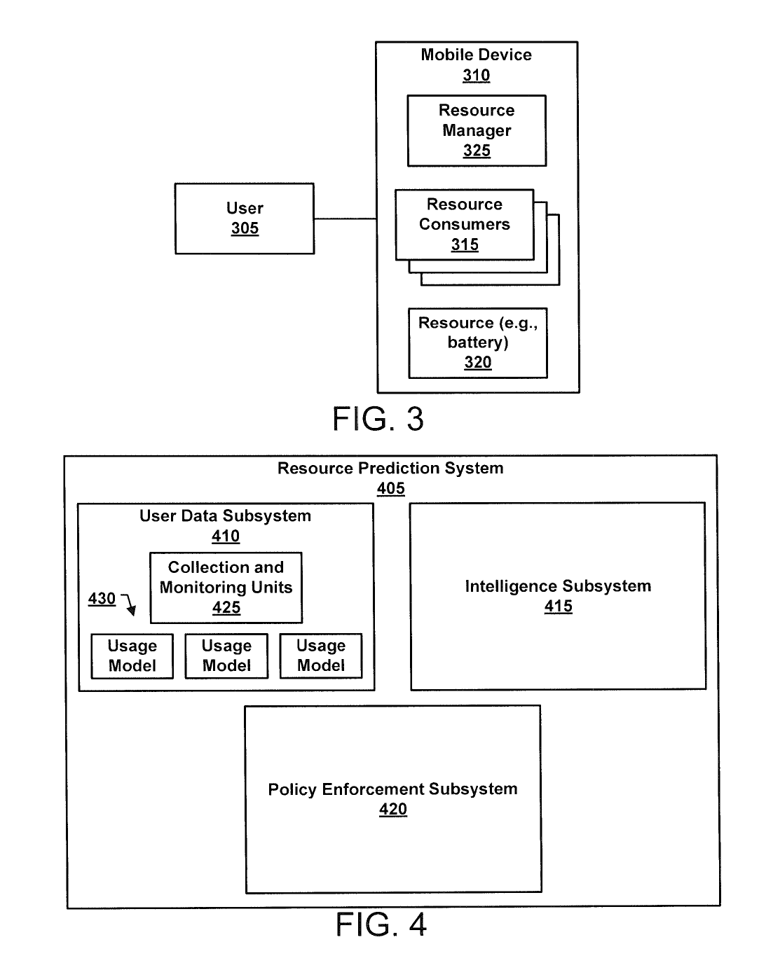

FIG. 3 shows a block diagram of a user 305 using a mobile communication device 310. The mobile communication device includes a set of resource consumers 315, a resource 320, and a resource manager 325. A resource consumer can be any application program, function, setting, option, configuration, or hardware component that consumes a resource of the mobile device. In a specific implementation, the resource includes a battery such as a lithium ion (Li-ion) rechargeable battery. Other examples of batteries include lead-acid, nickel cadmium (NiCd), nickel metal hydride (NiMH), and lithium ion polymer (Li-ion polymer).

The resource manager is part of a resource prediction system 405 (see FIG. 4) that uses contextual information to predict resource usage. The resource manager helps to ensure judicious use of a resource so that the resource can be available when needed. More particularly, mobile devices have a variety of sensors that can sense information about the user and the environment. These devices also have information on the state of device components and resources such as batteries, communications systems, processors, cameras, audio input and output devices, and on the state or configuration of applications installed or running on the device. Such information is referred to as contextual information.

It can be desirable to have applications and external services use contextual information to adapt how applications operate, to obtain additional information based on context for the user or for applications, or to feed external services like social or advertising networks.

Use of sensors and other sources of contextual information consumes resources on the device, such as energy from batteries, or communications bandwidth. Users of such devices have to cope with resource limits and resource exhaustion, such as network data usage limits being exceeded or batteries being drained. It can be desirable to have applications be context-aware and adapt their operation based on the current state of resources or other contextual information. Users and device administrators are not able to develop simple policies that work in all situations to conserve resources according to a user's current context.

It is difficult for users to try to manually manage application and service settings on the device to conserve resources for later use in the day. Device profiles are inadequate because the large number and variety of different contextual situations that users find themselves in would require manually creating and frequently switching among a large number of device profiles.

As more applications and external services attempt to use device contextual information, there is some duplication of effort in obtaining and using contextual information. Different applications may not adapt their operation in a consistent manner. Applications and external services may attempt to obtain and use contextual information in a manner that endangers the security or privacy of the user.

FIG. 4 shows a simplified block diagram of a system 405 configured to provide resource predictions. The features provided by the system may be implemented using a set of subsystems having one or more modules. The modules can be software modules (e.g., software instructions or code) executed by a processor, hardware modules, or combinations of these. The modules (or a subset of the modules) can be part of a computer software product implemented as an independent application (e.g., mobile application program or app) with data input and data display modules. In another specific implementation, the system may be provided within an operating system of the mobile device. In another specific implementation, the system provides prediction as a service to other applications such as through an application programming interface (API) or web service.

In a specific implementation, the one or more modules are distributed across a mobile device and a server system. Typically, a server has more computing resources than a mobile device. For example, a server may have more storage, more memory, faster and more powerful processors, and will not be dependent on a battery as a primary source of power as compared to the mobile device. Thus, one advantage of a distributed system is that processor intensive computing tasks such as those involving large datasets, data mining, pattern discovery, correlations, and the like can be performed on a server. The results of the server computations can be transmitted as instructions for the mobile device to follow and execute.

In another specific implementation, the modules are located on the mobile device and the processing is performed at the mobile device. An advantage of this approach is that the mobile device does not have to connect to the server system. For example, the mobile device may be in an area without network connectivity. However, the user will be provided the benefits of the resource prediction system because the modules are located on the mobile device.

The system, as shown in the example of FIG. 4, a user data subsystem 410, an intelligence subsystem 415, and a policy enforcement subsystem 420. The user data subsystem includes collection and monitoring units 425 to collect users' activity data related to usage of their mobile device. In one embodiment, the user data subsystem includes a usage model 430 that is created and stored for each user of the resource prediction system. A usage model represents the system's understanding of how a user uses the mobile device including the context in which such use occurs and other information that can be used to predict future use of a resource (e.g., battery).

In a specific implementation, context is used to automatically configure the mobile device. For example, in this specific implementation, the system may determine that the current context includes the user attending a meeting in a meeting room at his work location. Based on the current context, the system may automatically activate one or more policies that allow phone calls from family or emergency calls (e.g., call is being placed from a hospital) but block other phone calls, disable mobile device sounds (e.g. chimes), close background applications, and disable location service. Determining context allows the system to discover what the user is currently doing, anticipate or predict what the user is likely to do next, and configure the mobile device accordingly.

There can many different levels of context abstraction. For example, the context “commute to work” may be further detailed as “commute to work in car” or “commute to work on train.” These different levels of abstraction allow the system to provide very fine-grained control for adapting device behavior. Context can include geographical location information, applications used, time and date information, and other information. Further discussion is provided below.

The intelligence subsystem is responsible for building and creating the usage models by analyzing the usage data collected by the collection and monitoring units. The analysis can include pattern detection, event and activity correlation, comparisons, and detecting deviations from typical device usage. Based on the analysis, the intelligence subsystem makes a prediction about the resource.

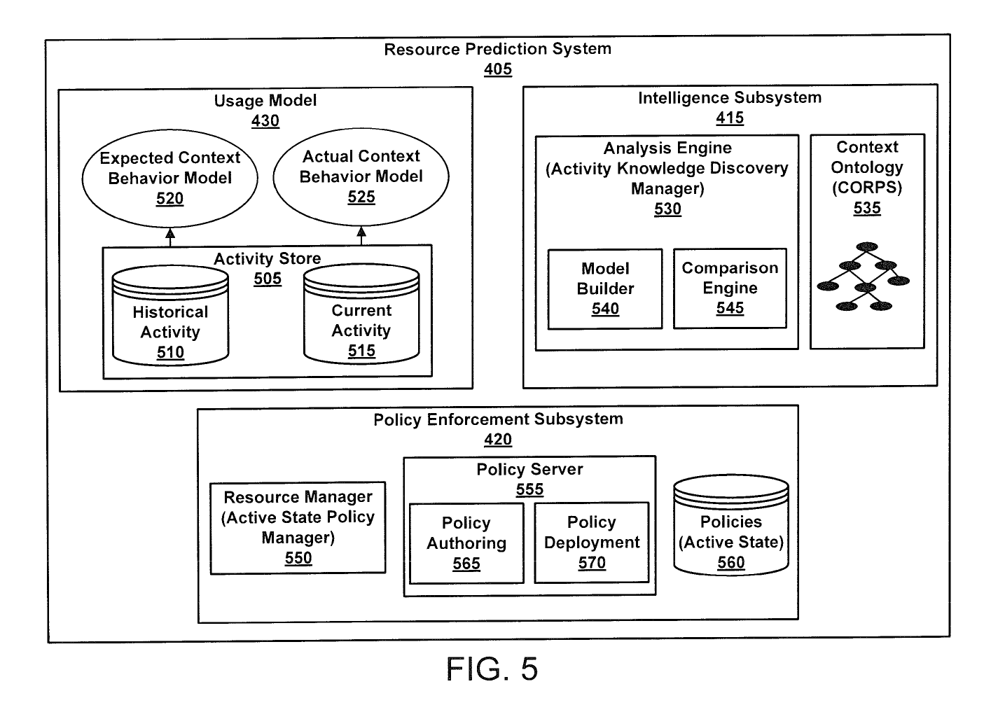

FIG. 5 shows a more detailed block diagram of the resource prediction system shown in FIG. 4. As discussed above, user data subsystem 410 as shown in FIG. 4 includes usage model 430 that is created by the prediction system and stored for each user of the system. The usage model includes an activity store 505 that stores historical activity data 510 and current activity data 515.

The system uses the historical activity data, and the current activity data to build an expected context behavior model 520, and an actual context behavior model 525, respectively. The expected context behavior model represents a user's expected behavior. For example, the expected context behavior model may include information that describes the user's activities on a typical day (e.g., weekday or weekend). The actual context behavior model represents the user's actual behavior. For example, the actual context behavior may include information that describes the user's activities during a current time period. The current time period may extend to the last minute, last five minutes, last 10 minutes, last 15 minutes, last 30 minutes, last hour, last two hours, or any duration of time that has elapsed as measured from the current time.

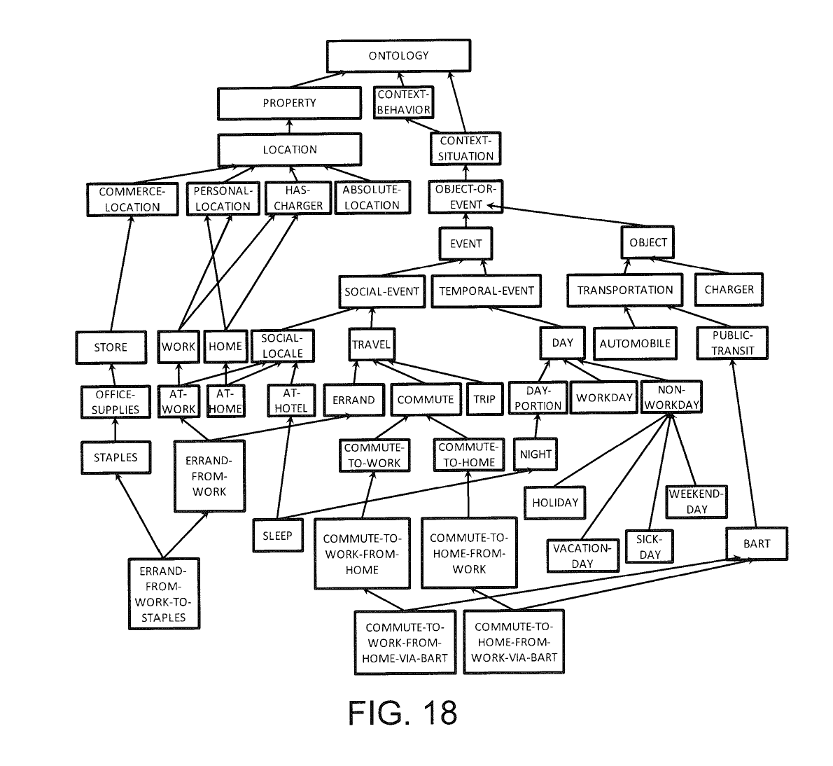

As shown in FIG. 5, intelligence subsystem 415 includes an analysis engine 530 and a context ontology 535. The analysis engine includes a usage model builder 540 and a comparison engine 545. The analysis engine may be referred to as an activity knowledge discovery manager. The context ontology includes a hierarchical arrangement of contexts. A context describes the conditions under which device usage, non-usage, or both occur. The conditions can include time, date, location, speed (e.g., tracking the movement of the device), and other factors (e.g., altitude, or temperature). For example, a portion of an ontology may include Location>Personal-Location>Home>Has-Charger. FIG. 18 shows a more detailed diagram of an example of an ontology. The context ontology may be referred to as the Context Ontology with Resource and Policy Semantics repository or CORPS. Further discussion of CORPS is provided below.

The model builder can act as a bridge between the context ontology and the data collected in the activity store to build the expected and actual context behavior models. The model builder can use the context ontology to tag, categorize, organize, classify, or label the activity data collected in the activity store.

The comparison engine can compare the actual context behavior model with the expected context behavior model to determine any deviations. For example, a user's expected morning routine may include relatively little use of the mobile device, but the user's afternoon routine may include heavy usage of the mobile device to, for example, make phone calls, run productivity applications, check email, and so forth. Consider, however, that for a particular morning the user's actual usage of the mobile device deviates such that actual usage is higher than expected. The higher morning usage uses more battery power than expected according to the expected context behavior model. Based on the higher than expected usage in the morning, the system may make a prediction that the battery charge level will not be sufficient for the user's afternoon routine. In this case, the system can activate resource reduction policies to help ensure that the battery charge level will be sufficient to support the user's afternoon routine. For example, the system may disable a service on the mobile device in order to conserve battery power.

Alternatively, if the actual usage is as-expected the system can permit the service to remain activated. Thus, the user can continue to enjoy the benefits of the service. If the actual usage is less than expected, the system can allow for increased usage of the battery. For example, the system may enable a service.

As shown in FIG. 5, policy enforcement subsystem 420 includes a resource manager 550, a policy server 555, and a policy repository 560. The policy server includes a policy authoring module 565 and a policy deployment module 570. The policy authoring module provides an interface such as a graphical user interface, programmatic interface, or both through which an administrator can create and edit policies. The policies are stored in the policy repository. The policy repository may be referred to as an active state. The policy deployment module is responsible for transmitting policies to the mobile device. Policies may be transmitted on an as-needed basis. This helps to conserve storage resources on the mobile device. Alternatively, policies may be preinstalled on the mobile device so that they can be immediately available when needed.

In an implementation, the resource manager is a module on the mobile device that manages usage of a mobile device resource according to an activated policy. The resource manager may be referred to as an active state policy manger. Further discussion is provided below.

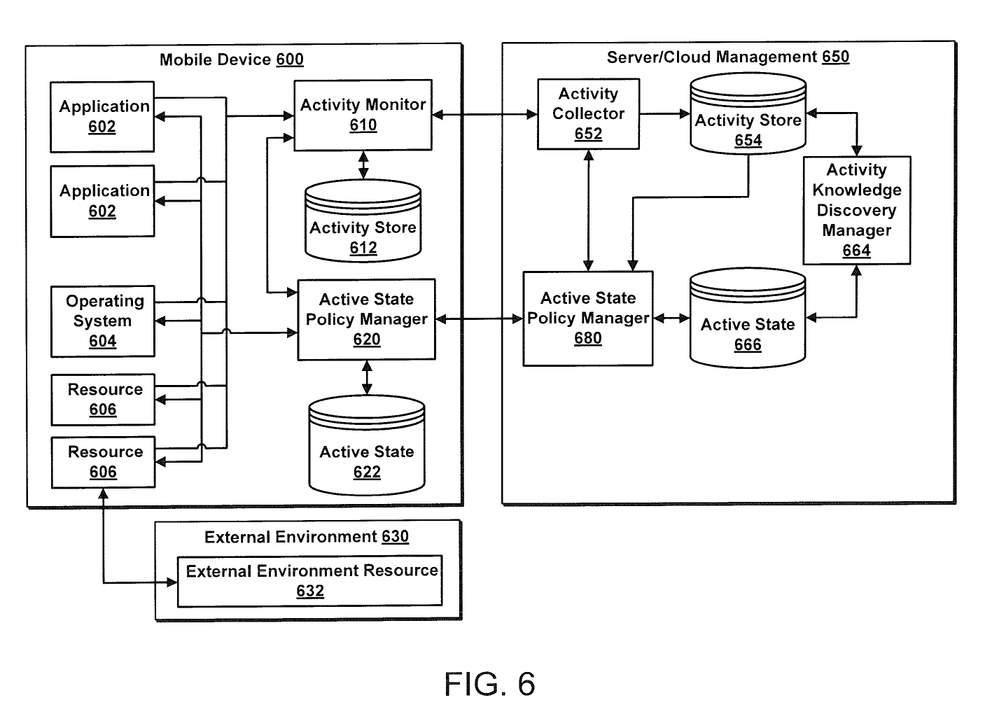

FIG. 6 shows a specific embodiment of the resource prediction system. According to the specific embodiment shown in FIG. 6, a mobile device 600 has a collection of mobile device elements, which include a plurality of applications 602, the operating system 604, and resources 606 used by the applications 602 and by the operating system 604.

Resources 606 include physical items like sensors or device components, or logical items like built-in services. Physical items can include but are not limited to batteries, processors, cameras, audio input or output devices, GPS devices, thermometer sensors, accelerometers, display screens or LED indicators, communications components like cellular communication chips, Wi-Fi communications chips, or batteries.

Logical items can include operating system software components or properties of physical items such as monthly data usage limits. Some resources 606 are exhaustible resources; as they are used, their capacity is reduced, and they can be exhausted. Examples include batteries or network data limits.

Other resources 606, the operating system 604, and applications 602 can in their operation have an effect on an exhaustible resource. The actions they take, their current state, and their configuration settings can all have a different degree of effect on an exhaustible resource.

Not shown in the figure is the presence of virtual machine technologies or device firmware logic. Firmware logic, which is conceptually below the level of the operating system, may have settings or operations which can be used in implementing policies. There can be a virtual machine layer underneath the level of the operating system, which may have settings or operations which can be used in implementing policies. Additionally, the operating system may have the ability to run virtual machine applications, each of which would have the ability to run an operating system and applications; any or all of these may have settings or operations which can be used in implementing policies. There are non-exhaustible resources which are nonetheless finite in some respect, such as memory or storage with respect to the number of bytes that can be stored, or such as CPU with respect to the number of processor cycles available in a given time interval. Any such non-exhaustible resource with a finite capacity can be modeled as a special kind of exhaustible resource with regards to the use of active policies to reduce or optimize resource utilization.

As discussed above, examples of the operating system 604 are the Android operating system used on various mobile devices, or the iOS operating system used on iPhone or iPad devices. Reference to the operating system 604 may also include its components or associated libraries, and any use of a virtualization mechanism which may be hosting and running the operating system or applications.

There may be external environment resources 632 in the external environment 630 which can include but are not limited to battery chargers, sensors, or services that can make information available to resources 606 or which can communicate with and be controlled by resources 606. External environment resources 632 are not properly part of the mobile device 600, although they may communicate with the mobile device 600 or may be sometimes connected to the mobile device 600.

An activity monitor 610 obtains information from applications 602, the operating system 604, resources 606 (which may include information obtained by resources 606 from external environment resources 632), or combinations of these. Such information can include but is not limited to application configuration settings, application current state or activities for running applications, actual application binaries or portions thereof, information provided by the operating system about its current state and settings, raw data information from the various resources, or combinations of these. The operating system may mediate access to some or all of this information.

The activity monitor 610 in its monitoring may obtain the information just once, or may subsequently again obtain the information, which may have changed. Subsequent acts of obtaining information may occur periodically, or may be driven by listening for changes in the information, or may be driven by requests or notifications from mobile device elements or the activity collector 652 or the active state policy manager 620 or 680. As an example, for a given time period, such as a 24-hour time period, the activity monitor may make a single collection of information or may make multiple collections of information.

The activity monitor 610 may store the information it obtains in a local activity store 612. The activity monitor may read the information stored in the local activity store 612 for communication with the activity collector 652, for communication with the active state policy manager 620, or both.

An active state policy manager 620 reads information from or stores information into a local data store called the active state 622. The active state policy manager 620 queries or modifies the settings or state of applications 602, the operating system 604, resources 606, or combinations of these. The active state policy manager 620 may also query or modify the settings or state of external environment resources 632. The active state policy manager 620 communicates with the active state policy manager 680 that is located in the server/cloud management service 650.

In one embodiment the active state policy manager 620 may modify an application 602 by embedding an executable policy into the application.

In another embodiment, the active state policy manager 620 may dynamically attach to an application 602, or to the operating system 604, or to a resource 606, in memory to implement policy enforcement.

In another embodiment, cooperating applications 602 may have been linked with libraries (that front end various calls or messaging in the application which receive or send context information or which access resources or the operating system) that communicate with the active state policy manager 620 to obtain permissions for actions.

In an embodiment the active state policy manager 620, via modification of or dynamic attachment to the applications 602, or the operating system 604, or the resources 606, or a combination thereof, mediates access from the applications 602 to context information available from the operating system 604 or the resources 606, providing its own version of the information or selectively denying access to such information. Its own version of the information could include cached copies of information previously retrieved, or information that has been standardized to hide details regarding the different models or types of resources providing the information, or information that has been modified or had some information removed for privacy reasons.

In an embodiment the active state policy manager 620 may take action on the mobile device elements (applications 602, operating system 604, resources 606). Actions can include starting an application, killing a running application, disabling a resource, or modifying the current state or configuration settings of an application or the operating system or resource. Actions can include the active state policy manager 620 directly and automatically taking the actions, or prompting the mobile device user for permission to take the actions, or suggesting to the mobile device user that the user take specific actions.

The server/cloud management service 650 runs on a plurality of servers, and may be provisioned in the cloud. A server/cloud management service 650 may communicate with multiple mobile devices 600.

The activity collector 652 communicates with the activity monitor 610 which is running on the mobile device 600. The activity collector receives information that has been obtained by the activity monitor 610 and stores it in the activity store 654 that is part of the server/cloud management service 650.

The activity knowledge discovery manager 664 reads information from the activity store 654 and using a variety of knowledge discovery in data techniques, including clustering, data mining, and machine learning techniques, discovers patterns of resource usage and creates resource predictions and writes them into the active state 666 store.

The active state policy manager 680 reads the information in the active state 666, optionally updated with selected unprocessed information from the activity collector 652. The active state policy manager 680 constructs, selects, or modifies policies and writes them to the active state 666 store. The active state policy manager 680 on the server/cloud management service 650 communicates information from the active state 666 store to the active state policy manager 620 that runs on the mobile device 600.

The activity collector 652 informs the activity monitor 610 regarding what information to collect and what information to forward to the activity collector 652. Some information may be monitored by the activity monitor 610 that is not forwarded to the activity collector 652.

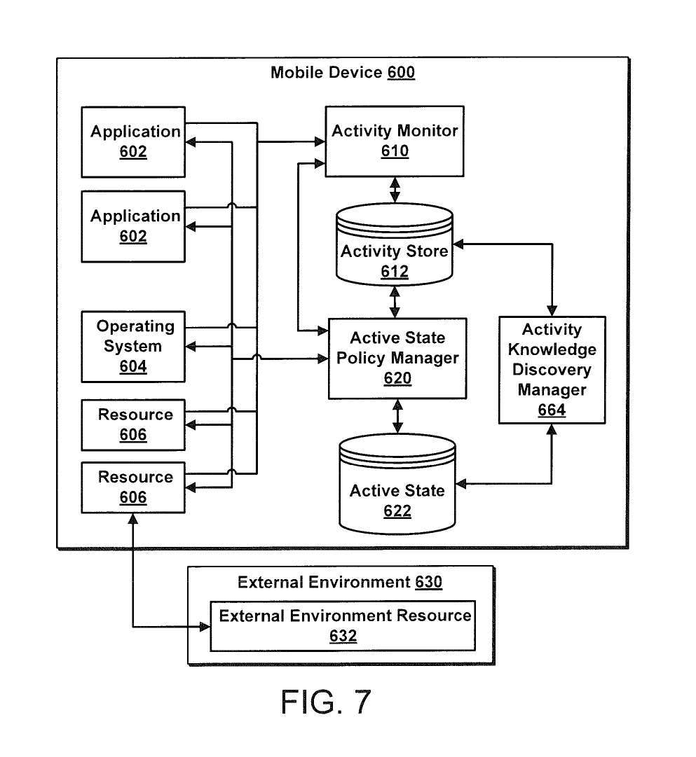

Referring now to FIG. 7, a system is illustrated similar to the one in FIG. 6, but in which there is no server/cloud management service, rather the management parts reside on the mobile device 600.

In another embodiment, the mobile device 600 can run all the elements as shown in FIG. 7, but the activity monitor 610 and active state policy manager 620 can be in communication with an activity collector 652 and an active state policy manager 680, respectively, that are part of a server/cloud management service 650. This is a hybrid embodiment in which the mobile device 600 can perform all the management activities but locally, but may communicate with a server/cloud management service 650.

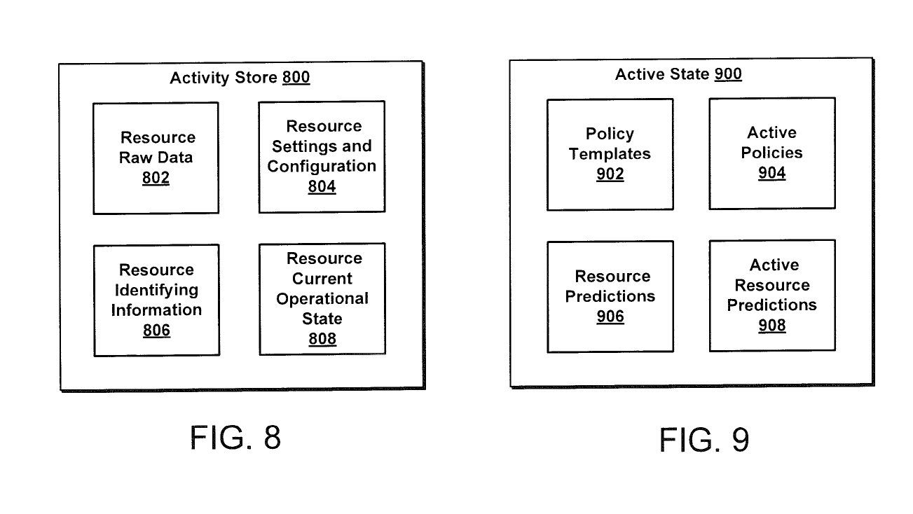

Referring now to FIG. 8, the activity store 800 is illustrated in greater detail. Information that identifies the specific instance of a resource (such as a serial number or other unique identifier, or the make or model or type of resource (such as brand and model number of a battery or processor or the name, software identifier [e.g., package name], and version of an application and information about the application publisher [e.g., name, signing certificate]) is included in the resource identifying information 806. Information that relates to the resource settings and configuration 804 is also part of the activity store 800; for an application this can include part or all of the application binary as installed on the mobile device 600 as well as configuration information for the application. The resource current operational state 808 includes those pieces of information such as, for a battery, whether it is currently charging or not, and what the current level of charge is.

For resources that are themselves sensors, there can be a stream of raw (unprocessed) data from the resource; this is the resource raw data 802. The resource settings and configuration 804 also contains information about the format and precision of the resource raw data 802 that the resource can supply. In an embodiment the activity monitor 610 or the activity knowledge discovery manager 664 may perform some processing on the resource raw data 802 to summarize or distill or categorize it, augmenting the resource raw data 802 in the activity store 800.

For the purposes of the activity store 800, resources can also include information obtained from external environment resources 632.

FIG. 9 illustrates the parts of the active state 900 store, which is represented as active state 622 and active state 666 in FIG. 6 and as active state 622 in FIG. 7.

A policy template 902 is constructed by and written to the active state 900 by the activity knowledge discovery manager 664, or can be manually authored by an administrator. A policy template is set of conditions and possible actions that can be taken on the mobile device 600 by employing the active policy manager to modify the functioning of an application 602 or the operating system 604 or a resource 606 or an external environment resource 632. A policy template may also have associated with it qualitative or quantitative measures of the results that a policy may have on resources.

For example, a policy template that changes the frequency that an email application checks for new mail to once every ten minutes instead of once a minute may qualitatively specify results of lowered battery/power usage, or may quantitatively specify results of reduced battery/power usage of so many mAh saved per hour.

A policy template 902 can be expressed in a number of ways. In one embodiment a policy template is a set of IF-THEN-ELSE rules which test properties of the current device conditions and take actions which can involve modifying the settings or configurations or current state of applications or the operating system or resources on the mobile device 600, or modifying the settings or configurations or current state of other elements of the environment that are external to the mobile device 600.

Using the example of a policy template that reduces the frequency of checking for email, this could be accomplished by modifying a setting in the email application. The email application may have an API or other interface that allows for changing this setting. The email application may store this setting in a configuration file, such that the setting can be modified by altering the configuration file, potentially requiring stopping and restarting the application to accomplish the change in setting. The email application might not expose such a setting, but might use an account sync service provided by the operating system, as in the Android operating system; in such a case the frequency of checking for new email can be accomplished by turning off the automatic sync operation, and periodically “waking it up” by turning it back on for a short period of time.

Other actions can involve sending notifications to the current user on the same or a different device, or executing a named procedure from the policy manager to solicit user input or approval for a tentative decision to take a particular action. In another embodiment a policy could be a piece of source code or executable code to be run on the device in the context of the device's policy manager. In another embodiment a policy could be a set of desired states or configuration settings. A policy template 902 is called a template because it may contain slots that can be filled by values from designated properties from the current device conditions by the active state policy manager 620 or 680.

An active policy 904 is a policy that is constructed by the active state policy manager 620 or 680 optionally using policy templates 902. An active policy 904 represents a policy that the active state policy manager 620 may conditionally enforce on the mobile device 600. Various pieces of information that are specific to a particular device or user may be filled in when turning a policy template into an active policy that is to be running on a device. In a specific implementation, policy templates are organized hierarchically. A higher-level policy template may define a high-level set of goals, such as reducing network traffic and resulting battery usage by reducing frequency of checking for updates for new content. Hierarchically below this may be policy templates for accomplishing the higher-level goal for specific applications, e.g., an email application, Facebook, etc. Further down the hierarchy may be policy templates that are device specific, e.g., the policy template for reducing the frequency of checking for new mail in the Gmail application could be different on an Android device vs. on an iPhone. The expected results on resources associated with a policy template (and with an instantiated policy) are used to modify resource predictions.

Thus, the active state policy manager 620 or 680 can choose a plurality of active policy templates which can be turned into active policies to run on the device. The choice uses the expected impact of the policy upon the resource to determine which and how many active policies should be activated, and what settings they should be using. E.g., the active policy manager can select the active policy templates with the largest anticipated impacts on reducing resource usage, continuing to activate more active policy templates until the aggregate impact on resource usage is low enough to allow the resource exhaustion point to occur at or after the acceptable earliest resource exhaustion point.

The resource predictions 906 are constructed and written to the active state 900 by the activity knowledge discovery manager 664. A resource prediction 906 is based on information that has been gathered into the activity store 612 or activity store 654. A resource prediction 906 is a prediction of what is likely to happen with respect to a resource over time. This can include expected rates of resource usage, usual network locations contacted, usual applications executed, and frequency of certain activities performed on the mobile device 600 by applications 602 or the operating system 604 or resources 606.

An active resource prediction 908 is a specific instantiation of a resource prediction 906 corresponding to conditions pertaining on the mobile device 600 at this point in time.

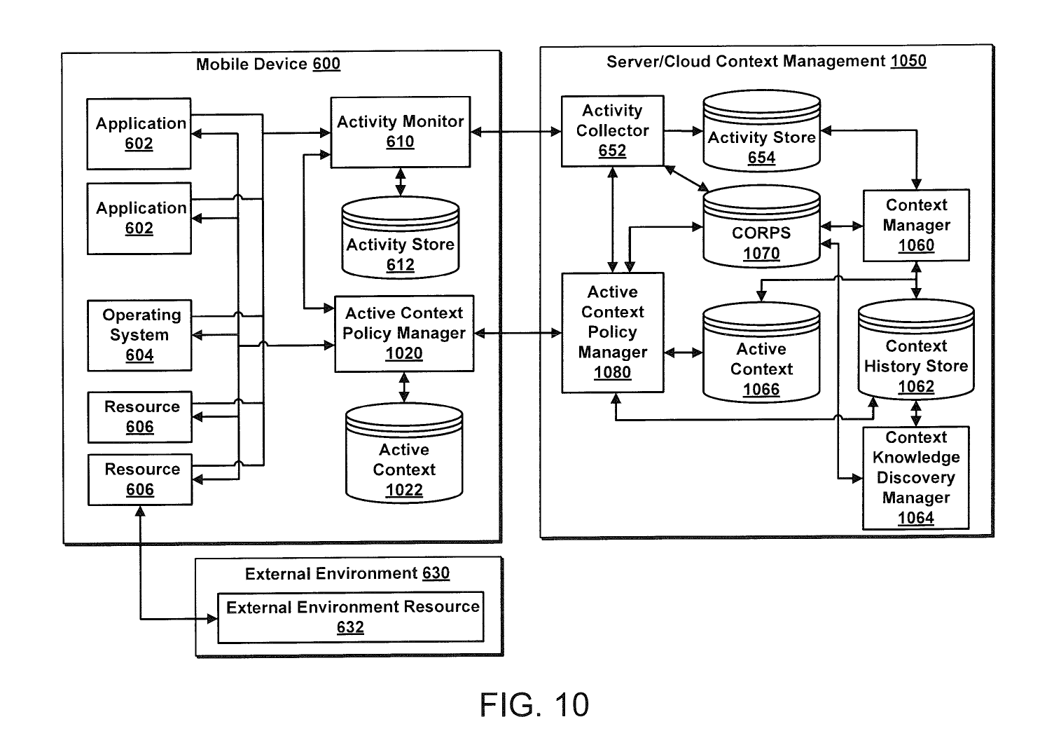

According to a specific embodiment shown in FIG. 10, a mobile device 600 runs a plurality of applications 602, which are controlled by the operating system 604, which supports use of resources 606 by the applications 602.

An activity monitor 610 obtains information from applications 602, the operating system 604, resources 606, or combinations of these. The activity monitor 610 in its monitoring may obtain the information just once during a particular time period, or may subsequently again obtain the information during the particular time period, which may have changed. Subsequent acts of obtaining information may occur periodically, or may be driven by listening for changes in the information, or may be driven by requests or notifications from mobile device elements or the activity collector 652 or the active context policy manager 1020 or 1080.

The activity monitor 610 may store the information it obtains in a local activity store 612. The activity monitor may read the information stored in the local activity store 612 for communication with the activity collector 652, for communication with the active context policy manager 1020, or both.

An active context policy manager 1020 reads information from or stores information into a local data store called the active context 1022. The active context policy manager 1020 queries or modifies the settings or state of applications 602, the operating system 604, resources 606, or combinations of these. The active context policy manager 1020 communicates with the active context policy manager 1080 that is located in the server/cloud context management service 1050.

In one embodiment the active context policy manager 1020 may modify an application 602 by embedding an executable policy into the application.

In another embodiment, the active context policy manager 1020 may dynamically attach to an application 602, or to the operating system 604, or to a resource 606, in memory to implement policy enforcement.

In another embodiment, cooperating applications 602 may have been linked with libraries (that front end various calls or messaging in the application which receive or send context information or which access resources or the operating system) that communicate with the active context policy manager 1020 to obtain permissions for actions.

In an embodiment the active context policy manager 1020, via modification of or dynamic attachment to the applications 602, or the operating system 604, or the resources 606, or a combination thereof, mediates access from the applications 602 to context information available from the operating system 604 or the resources 606, providing its own version of the information or selectively denying access to such information. Its own version of the information could include cached copies of information previously retrieved, or information that has been standardized to hide details regarding the different models or types of resources providing the information.

In an embodiment the active context policy manager 1020 may take action on the mobile device elements (applications 602, operating system 604, resources 606). Actions can include starting an application, killing a running application, disabling a resource, modifying the current state or configuration settings of an application or the operating system or resource, or combinations of these. Actions can include the active context policy manager 1020 directly and automatically taking the actions, or prompting the mobile device user for permission to take the actions, or suggesting to the mobile device user that the user take specific actions.

The server/cloud context management service 1050 runs on a plurality of servers, and may be provisioned in the cloud. A server/cloud context management service 1050 may communicate with multiple mobile devices 600.

The activity collector 652 communicates with the activity monitor 610 which is running on the mobile device 600. The activity collector receives information that has been obtained by the activity monitor 610 and stores it in the activity store 654 that is part of the server/cloud context management service 1050.

The CORPS 1070 is the Context Ontology with Resource and Policy Semantics repository. The CORPS 1070 contains knowledge about resources, their characteristics, the kinds and ranges of measurements that they can be made, rules for how to transform resource raw data to low-level or high-level contextual information, templates for possible policies regarding data security, privacy, resource usage, or context adaptation for applications, operating system components, or resources.

The CORPS 1070 contains knowledge about what are referred to as context abstractions, specifically, context situations and context behaviors. In general the term context refers to any information that can be used to describe the internal state of an entity, where an entity is a person, place, or object or part thereof that is considered relevant to any interaction between a user and applications, and the external state of other entities or the environment, where environment refers to the computing environment of the device and its components and operating system and applications as well as to the external physical environment of the device and the user. This includes the user and the applications themselves.

Some context information is measurable directly by sensors; this is referred to as resource raw data, or low level data. Other context information requires preprocessing of low-level data; the resulting information is a form of high level data. Context abstractions are conceptual formulations of specific types and values of contextual information. FIG. 18 shows a subset of the CORPS ontology that can be used for making context-based predictions.

A set of high level data categories with particular values for the high level data may be called a context situation. This feature may be referred to as context-awareness. For example, a set of processed context information regarding device location over time may show that the device is moving at a speed of 2.5 miles per hour (mph). This set of high-level data (which was generated by processing low-level position data over time) corresponds to a context situation, one that could be conceptually labeled as LOW-SPEED-MOTION.

A different set of high-level data from an accelerometer sensor on the mobile device could after preprocessing be determined to represent the small shocks of feet hitting the ground at a regular pace of 1.5 times per second, which corresponds to a normal pace of foot-ground impacts when walking. This context situation could conceptually be labeled as TAKING-STEPS.

Note that neither of the two context situations above necessarily implies that the user is walking (moving on foot). In the former case, the user could be riding in a low speed conveyance and not walking. In the latter case, the user could be walking in place and not moving anywhere. If both context situations, LOW-SPEED-MOTION and TAKING-STEPS are occurring at the same instant in time, this likely represents a higher level conceptual context situation WALKING. The WALKING context situation has fused information from multiple sources and represents an inference, or the result of a reasoning process on other context situations. All three context situations can be considered as active at this point in time.

The manner in which conceptual context situations are related to each other is an ontology. An ontology is a lattice of nodes corresponding to concepts that have various properties or values, and in which nodes may have various relationships to other nodes; in this definition we use the mathematical meaning of the term lattice. The use of the ontology allows for the economical composition of context situations that have different levels of granularity, or represent successively more complex or abstract context situations. Context situations are modeled in the ontology according to their potential usefulness in other activities, such as defining policy rules for context adaptation, or for data security or privacy enforcement. The ontology can be expressed using a variety of formats, such as OWL (Web Ontology Language) or KIF (Knowledge Interchange Format).

A context situation is something that is happening at a particular point in time. Context information can change, which means that a given context situation may no longer be active or current because of the change in context information, but a new context situation may now be active or current. Multiple context situations can be active at any point in time, either because the context situations represent different levels of abstraction, or because they relate to different dimensions of context, or because they are compositions of multiple concurrent context situations.

For example, the context situations COMMUTE and COMMUTE-TO-WORK and COMMUTE-TO-WORK-FROM-HOME and COMMUTE-TO-WORK-FROM-HOME-VIA-BART (or TRAIN) may all be active at the same time, but they represent different levels of abstraction. The context situation USING-EMAIL-APP may be occurring at the same time as all of these other context situations. More specific combinations of co-ocurring context situations can be made explicit and labeled to the extent that they are useful for policy management.

For example, if it were useful, the context situation USING-EMAIL-APP-WHILE-COMMUTING-TO-WORK-FROM-HOME-VIA-BART could be made explicit. In general, the Context Manager decides how far to go in recording information about combination context situations based on how frequently they occur in the user and device history. A highly detailed combination context situation that only has ever occurred once is not likely to be useful in the future, and thus would not be explicitly represented.

On the other hand, a highly detailed combination that occurs very frequently could be useful in making resource predictions. A sequence of context situations is one form of what may be called a context behavior. The context behavior could involve major changes in context situation, such as the user leaving work, and then commuting home. This is a sequence context behavior.

Another form of a context behavior is one in which there are multiple context situations involved, but a higher level context situation may still be active throughout the entire context behavior. An example is a context behavior in which the context situation AT-WORKPLACE is active for eight hours, during which a variety of lower level context situations such as WALKING, MEETING, and TYPING occur. This is an aggregate context behavior.

Both context situations and context behaviors can have different levels of abstraction, or different granularities of time resolution, and can contain other sequences or context behaviors.

The context manager 1060 reads information from the activity store 654 and is responsible for processing the resource raw data, settings, configurations, identifying information and operational state into higher level context information. The context manager uses the information in the CORPS 1070 to perform its processing, and to populate information into the active context 1066 and the context history store 1062.

The context knowledge discovery manager 1064 reads information from the context history store 1062 and using a variety of using a variety of knowledge discovery in data techniques, including clustering, data mining, and machine learning techniques, discovers patterns of resource usage and creates resource predictions, context situation predictions, and context behavior predictions and writes them into the context history store 1062.

The active context policy manager 1080 reads the information in the active context 1066, optionally updated with selected unprocessed information from the activity collector 652. The active context policy manager 1080 uses the information in the CORPS 1070, especially the policy templates, constructs, selects, or modifies policies and writes them to the active context 1066. The active context policy manager 1080 on the server/cloud context management service 1050 communicates information from the active context 1066 to the active context policy manager 1020 that runs on the mobile device 600.

The activity collector 652 uses control information from the CORPS 1070 to inform the activity monitor 610 regarding what information to collect and what information to forward to the activity collector 652. Some information may be monitored by the activity monitor 610 that is not forwarded to the activity collector 652.

In one embodiment an application 602 that is aware of the context infrastructure may provide candidate application-related policies to the active context policy manager 1020. Doing so allows the application 602 to be actively managed according to policy, whether that is a policy provided by the application 602 itself, or new or modified policies being managed by the active context policy manager 1020. Modifications to policies can be made by mobile device users, or by suitably authorized administrators for the mobile device (such as enterprise administrators in a corporation or parents in a family), or by dynamic modifications to active policies generated locally by the active context policy manager 1020 or the remote active context policy manager 1080.

In another embodiment an application 602 that is aware of the context infrastructure may provide definitions of context situations or context behaviors that are of particular interest to the functioning of the application, and which are not already present within the CORPS 1070. Such applications can query current state represented in the active context 1022 or subscribe to notifications regarding the content in the active context 1022 by making requests of the active context policy manager 1020.

In one embodiment the mobile device 600 is temporarily not in communication with the server/cloud context management service 1050. In this embodiment the active context policy manager 1020 is updating the active context 1022 directly using information from the activity monitor 610. In a related embodiment, there is additionally a copy of the context manager 1060 running also on the mobile device 600, which uses a subset of the CORPS 1070, also residing on the mobile device 600. The subset is just that information related to CORPS 1070 information that is known to be relevant to this particular mobile device, this user, and frequent or predicted context situations and context behaviors for this device and this user, together with associated policy templates. In this embodiment the mobile device 600 continues to be capable of active management of policies regarding context adaptation and context information privacy and security.

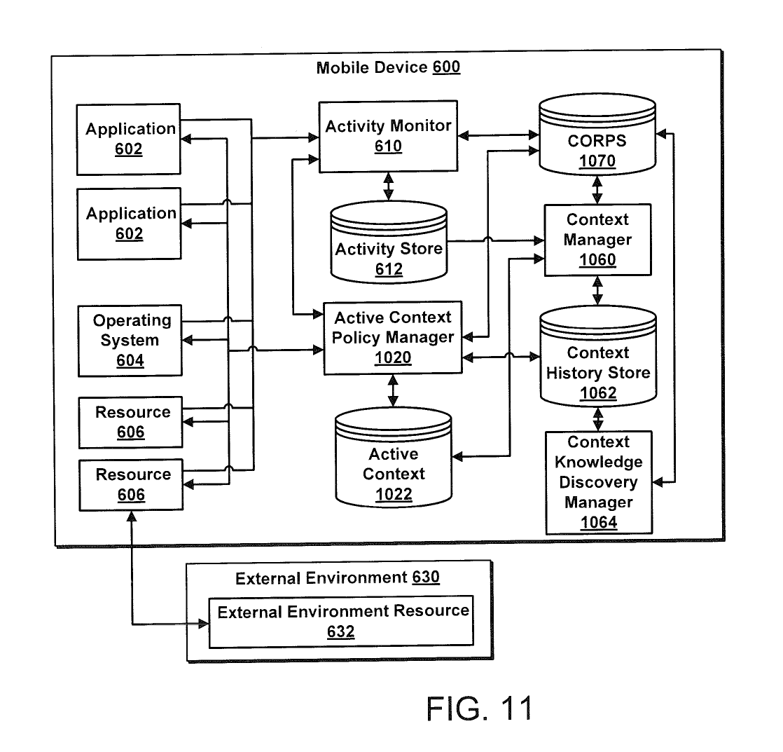

Referring now to FIG. 11, we see a mobile device 600 that is running all the elements of a context management service on the device itself. Specifically, there is a CORPS 1070, a context manager 1060, a context history store 1062, a context knowledge discovery manager 1064. In this configuration the context management service is capable of running indefinitely on the mobile device without requiring communication with an external server or cloud-based context management service.

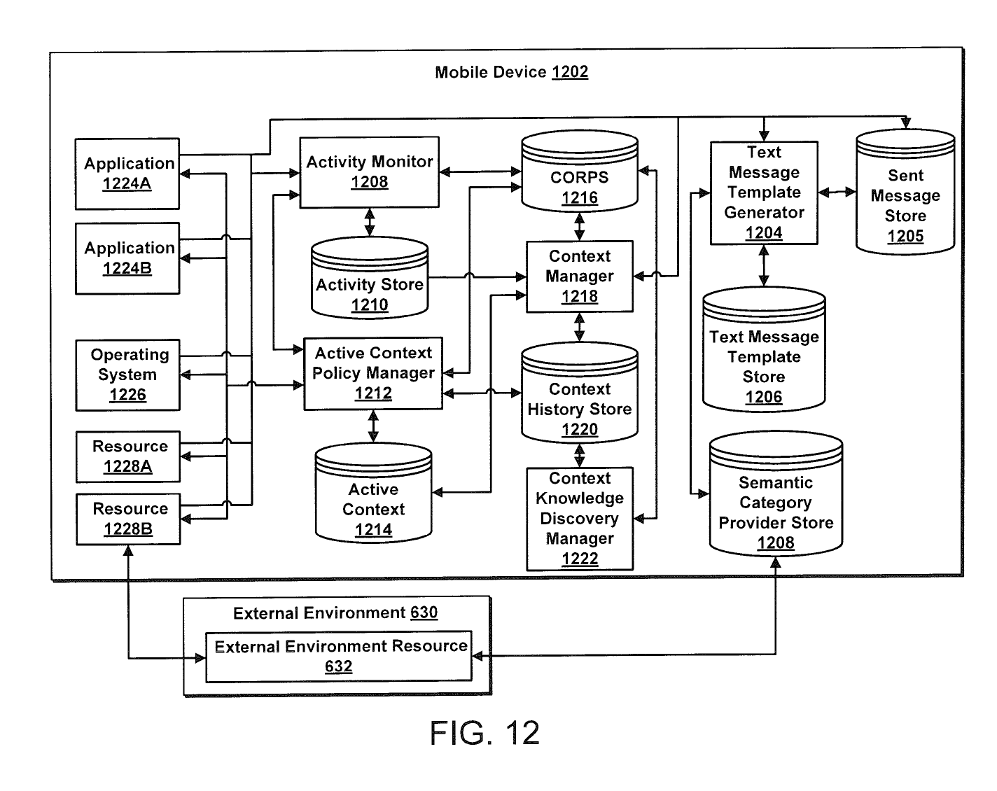

Referring now to FIG. 12, a block diagram is shown of a system that includes a mobile device, where the mobile device includes a text message template generator and a context management service. Accordingly, system 1200 may include mobile device 1202, which may be a mobile communications device, such as a smartphone, or a tablet computer, electronic reader, or any other mobile computing platform. Mobile device 1202 may include one or more processors capable of executing and running one or more applications, and may further include one or more storage volumes capable of storing data associated with the one or more applications. Thus, multiple applications may be running on mobile device 1202 at a particular time. Mobile device 1202 may be capable of sending and receiving text messages, such as short message service (SMS) messages. Thus, one or more applications running on mobile device 1202 may generate, send, receive, and store text messages.

Mobile device 1202 may include text message template generator 1204, which may be an application capable of generating templates for text messages. A text message template may be a string of text representative of a message that may be frequently sent by a user. The string of text may include several text fields which function as placeholders for one or more data values that may be included when the text message template is used to compose a text message. Text message template generator 1204 may be further configured to aggregate and process information that may be included in various text fields of the text message templates.

Text message template generator 1204 may generate text message templates based on text messages that have been previously sent from mobile device 1202 by a user of mobile device 1202. Mobile device 1202 may store copies of text messages that are sent in sent message store 1205, which may be a physical or virtual memory device capable of storing text messages. In various embodiments, text message template generator 1204 queries sent message store 1205 to retrieve one or more stored sent messages. Text message template generator 1204 may directly query sent message store 1205. Alternatively, operating system 1226 may mediate communications between text message template generator 1204 and sent message store 1205.

In various embodiments, text message template generator 1204 analyzes the text messages that were retrieved from sent message store 1205 to identify new text message templates. Text message template generator 1204 may perform one or more natural language processing operations on one or more retrieved text messages to generate text message templates. Thus, a text message template may be a result of one or more natural language processing operations performed on text messages that were previously sent from mobile device 1202.

For example, text message template generator 1204 may perform a morphological, syntactic, and semantic analysis to identify sentences or sentence fragments in the sent text messages that contain one or more items associated with one or more semantic categories. A semantic category may be a grouping of items identified based on their meaning. For example, a semantic category may be a location, event, agent, or time. Thus, text message template generator 1204 may analyze a sentence and identify an item belonging to a semantic category, such as a movement verb (e.g., leave, left, arrived, got here, reached, etc.) or a location.

Text message template generator 1204 may convert the sentence or sentence fragment into a text message template by replacing the identified item with a data field, such as a text field. The data field may provide a placeholder which may be subsequently replaced or filled in by a different value, such as an item selected from a semantic category. For example, a sent text message may include a location, such as the word “work”. The word “work” may be replaced with a data field shown as “[LOCN]” to create a template that describes a location, but is not specific to the location “work”. In this example, the text message “I am going to work” may be converted into the text message template “I am going to [LOCN]”, where “[LOCN]” is a text field that functions as a placeholder for items included in the semantic category LOCATION. Similarly, sentences or sentence fragments which contain date or time references can be converted to text message templates by changing the actual date or time references to “[DATE]” or “[TIME]”.

In various embodiments, the text message templates that are generated may be candidate text message templates that may be presented to a user of mobile device 1202 for review. The user may manually select and add the candidate text message templates to a list of text message templates. In another example, text message template generator 1204 may automatically select and add a candidate text message template to a list of text message templates based on information, such as metadata, associated with the underlying text message or the candidate text message template itself In some implementations, text message template generator 1204 may monitor a frequency or number of occurrences at which a candidate text message template is generated, and compare that frequency or number of occurrences with a threshold value. For example, if the same candidate text message template is generated from a dozen different text messages sent by the user, then this candidate text message template may be stored and added to a list of text message templates automatically based on its high frequency and number of occurrences.

In some embodiments, the text message templates that are generated may be sorted or arranged into different groups or lists that are associated with different semantic categories. The lists may be displayed when their associated semantic categories are invoked. Thus, different text message template categories may have different lists of text message templates associated with them. Different text message template categories can be active at different times, or in different contexts. Moreover, text message template generator 1204 may be configured to apply a ranking scheme to the text message templates that it generates. The ranking scheme may rank the text message templates based on retrieved context information, situations, and behaviors.

For example, one or more categories of text message templates associated with a user's home or family may become active or ranked with higher priority when mobile device 1202 determines that the user is close to his or her house, as may be determined based on an analysis of context information such as data retrieved from a global positioning system (GPS).

In another example, a text message template including the text “honey I'm home” may be ranked based on a context situation. In this example, the text message template may be highly ranked in the evening when a user is likely to be coming home. The same text message template may be ranked lowly in the morning when a user is more likely to be leaving home than coming home.

Moreover, the contents or a presentation of a list of text message templates may be determined dynamically. For example, if a text message template has not been used for a predetermined amount of time, such as several weeks, then the text message template may be given a lower priority position in the list of text message templates, or the text message template may be removed from a list of text message templates that may be presented to a user.

Categories of text message templates may also be created for security purposes. For example, a text message template category may be a category named “Security”. A text message template belonging to this category may be used to quickly and reliably forward a suspicious email to a security administrator. Thus, the text message template may include the text “I think I received a phishing email [EMAIL.RECENT] [TO:“securityAdmin@company.com”]”. In this example, an application, such as an email client, may provide context information for a semantic category “EMAIL”. The template may also specify a sub-content type “RECENT” that restricts the context information that is retrieved to context information that was generated recently. In this example, the recent context information would be a recently received email. Thus, a recently received suspicious email may be automatically attached to the text message. The text field “[TO:‘securityAdmin@company.com’]” may be a pre-populated text field that is not displayed in the body of the text message, but instead displayed in a separate field that identifies the recipient of the text message.

In some embodiments, a user may create text message template categories. For example, a user may create a category named “Status” which may be configured to store text message templates that relate to the user's status. The user may also select which candidate text message templates are included in the category that the user has created. Furthermore, a user may define or specify one or more conditions or criteria that cause text message template generator 1204 to include a candidate text message template in the user created category.

Text message template generator 1204 may have an associated data store, such as text message template store 1206. Thus, the text message templates that result from the analysis performed by text message template generator 1204 may be stored in text message template store 1206. Text message template store 1206 may be queried and text message templates may be retrieved when a text message is being composed by a user.

Text message template store 1206 may maintain the text message templates in one or more data objects. Thus, different text message templates may be stored in different data objects. A group of text message templates all belonging to a particular semantic category may be stored in a data object as a list associated with that semantic category. For example, several text message templates may have been generated that describe a user's status in relation to a particular location. In this example, the text message templates may include the same or similar text to the message “I'm leaving [LOCN].” These text message templates may all be grouped and stored in text message template store 1206 as a list of text message templates associated with the semantic category STATUS and/or LOCATION.

Mobile device 1202 may also include various elements of a context management service, as similarly discussed with reference to FIGS. 10 and 11. For example, mobile device 1202 may include semantic category provider store 1208, which may store a hard coded list of semantic category providers. Thus, semantic category provider store 1208 may provide a predetermined listing of resources or applications on or off mobile device 1202 that may provide information associated with one or more semantic categories. The list may be queried by operating system 1226 and applications or resources identified in the list may be registered as semantic category providers. In some embodiments, the hard coded list may be defined by a user or by a software developer. The hard coded list may be stored or modified by an application on mobile device 1202, or by external environment resource 632.

As similarly discussed with reference to FIG. 10, mobile device 1202 may include activity monitor 1208. Activity monitor 1208 may obtain information from applications 1224A and 1224B, operating system 1226, resources 1228A and 1228B, or any combinations thereof. Activity monitor 1208 may monitor and obtain information once during a particular time period, or may subsequently obtain information during the particular time period, since the information may have changed in the intervening time. Subsequent acts of obtaining information may occur periodically, or may be driven by listening for changes in the information, or may be driven by requests or notifications from mobile device elements.

Mobile device 1202 may also include CORPS 1216, which, as similarly set forth above with reference to FIG. 10, is a Context Ontology with Resource and Policy Semantics repository. CORPS 1216 contains knowledge about resources, their characteristics, the kinds and ranges of measurements that they can make, rules for how to transform resource raw data to low-level or high-level contextual information, templates for possible policies regarding data security, privacy, or context adaptation for applications, operating system components, or resources. Thus, CORPS 1216 contains knowledge about how to communicate with other applications and process data retrieved from those applications.

Furthermore, CORPS 1216 may include knowledge about context abstractions, such as context situations and context behaviors. As previously discussed, an example may be processing low-level data received from sensors on mobile device 1202 to categorize a user's speed as low-speed motion.

In some embodiments, CORPS 1216 may include one or more ontologies. For example, there may be an ontology that is used to model one or more semantic categories. Thus, the ontology may include a network of interrelated nodes that model the semantic category LOCATION. The ontology may model other semantic categories as well. The ontology may be used to map context behaviors and situations to semantic categories. For example, a particular location, such as “work” may exist as an entity in the ontology, and may be abstracted up to “location” as determined by a series of interrelated nodes. In some implementations, the level of abstraction may be varied. Thus, instead of being mapped to “location”, a user's current location may be mapped to terms of varying granularity, such as a street name, a city name, or a longitude and latitude. CORPS 1216 may store information used to process context information, such as rules and policies, while context manager 1218 may perform the processing involved in an ontological semantic analysis of the context information.

Accordingly, context manager 1218 reads information from activity store 1210 and is responsible for processing the resource raw data, settings, configurations, identifying information and operational state into higher level context information. Context manager 1218 may use the information in CORPS 1216 to perform its processing, and to populate information into active context 1214 and context history store 1220.

Context manager 1218 may also be configured to process context information retrieved from multiple sources for presentation to a user at a display of mobile device 1202. Therefore, while text message template generator 1204 may generate text message templates that include data fields representative of semantic categories, context manager 1218 may manage information associated with the data fields. Returning to a previous example, if a data field represents a location (e.g. [LOCN]), context manager 1218 may manage one or more items, such as words, associated with that location. For example, the items may be words identifying locations, such as “work”, “home”, and “BART”.

The items associated with each semantic category may be retrieved from one or more semantic category providers, which may be applications or resources that provide information about one or more semantic categories. As discussed in greater detail below with reference to applications 1224A and 1224B, applications and resources may be registered as semantic category providers that provide information associated with a semantic category in response to detecting an event. For example, applications on mobile device 1202 may provide one or more items associated with a semantic category included a text message template in response to receiving a request from text message template generator 1204.

In some embodiments, context manager 1218 may be configured to rank items received from other applications or resources. Ranking the items may determine an order in which they may be presented when displayed on a display of mobile device 1202. Context manager 1218 may use data or metadata associated with the received items as the basis of determining a ranking of the items. For example, context manager 1218 may analyze associated metadata to rank the contents of an email message based on how recently the email message was sent. Context manager 1218 may also rank an item based on how frequently it is used, or rank an item based on a combination of frequency and recency.

In another example, context manager 1218 may rank items in a semantic category based on context situations or context behaviors. A context situation may represent a combination of an activity, a location, and a duration of the activity. A context behavior may represent a series or pattern of items that occur closely together. Thus, items included in a semantic category may be ranked based on context information that identifies context situations and behaviors associated with the each of the items. Moreover, the ranking may be performed dynamically and based on the most recent context information available. For example, items included in the semantic category LOCATION may be ranked based on a distance between the item's location and the user's current location.

In another example, context manager 1218 may rank context information based on more than one criterion, or based on a different set of context information. In this example, context manager 1218 may have processed multiple items and sorted them into their respective semantic categories, such as LOCATION and TIME. Context manager 1218 may rank items included in the LOCATION category based on a time associated with each LOCATION item, a distance between the location item's location and the user's current location, and how frequently the location item appears. For example, a location item that is rare but occurred recently may be highly ranked, while a location item that is frequent but old is lowly ranked.

In various embodiments, a ranking associated with context information may be determined by one or more components other than context manager 1218. For example, an application that provides email services may provide sentences and text included in email messages to text message template generator 1204. The email application may rank the information that is sent to text message template generator 1204 by including the information in a data object in an order determined based on associated metadata, such as how recently an email message was sent or how frequently the email message recipient is emailed.

As similarly discussed with reference to FIG. 10, the context management service may also include active context policy manager 1212, which may read information from or store information into a local data store called the active context 1214. Active context policy manager 1212 may query or modify the settings or state of applications 1224A and 1224B, operating system 1226, resources 1228A and 1228B, or combinations thereof.

Context knowledge discovery manager 1222 reads information from context history store 1220 and using a variety of knowledge discovery in data techniques, including clustering, data mining, and machine learning techniques, discovers patterns in contextual information and creates context situation predictions, and context behavior predictions and writes them into the context history store 1220.

Operating system 1226 may manage hardware resources of mobile device 1202 and mediate communications between applications running on mobile device 1202. Operating system 1226 may be an operating system that is optimized for operation on a mobile device, such as Android®, Windows Phone®, or iOS®. Operating system 1226 may manage system wide usage of the hardware and software resources available to mobile device 1202. For example, resources 1228A and 1228B may be one or more hardware or software resources that may be used to run applications or services on mobile device 1202. Operating system 1226 may interact with and manage the use of resources 1228A and 1228B on mobile device 1202.

Applications 1224A and 1224B may be one or more applications that are running on mobile device 1202. For example, application 1224A or 1224B may be an application that monitors the physical environment of a user, tracks a location of a user, manages a user's calendar and appointments, provides email services to the user, or provides security services for the mobile device. Thus, applications 1224A and 1224B may provide services for mobile device 1202 and aggregate various types of data associated with those services. For example, a calendaring application may aggregate data about a location at which a user should be at a particular time.

In some embodiments, applications 1224A and 1224B may provide information to text message template generator 1204. Applications 1224A and 1224B may be in direct communication with and may provide the information directly to text message template generator 1204. Alternatively, operating system 1226 may mediate communications between applications 1224A and 1224B and text message template generator 1204. In this instance, applications 1224A and 1224B may be registered with operating system 1226 as semantic category providers. The registration process registers the applications as listeners that listen for a particular event, such as a request issued by another application. When text message template generator 1204 issues a request for information, the request is forwarded to operating system 1226, which then broadcasts the request to all registered semantic category providers. In response to receiving the request, the registered providers, such as applications 1224A and 1224B, may provide a response that includes any requested information. The responses may be forwarded to text message template generator 1204 by operating system 1226.

As similarly discussed above with reference to FIG. 10, external environment 1230 may be a computing environment of mobile device 1202 as well as an external physical environment of the device and the user. Thus, external environment 1230 may include various computing and network components as well as physical components in which mobile device 1202 operates. External environment 1230 may include external environment resource 1232 which may be an external source of information provided to mobile device 1202. For example, the information may be the data values of the hard coded list stored in semantic category provider store 1208.

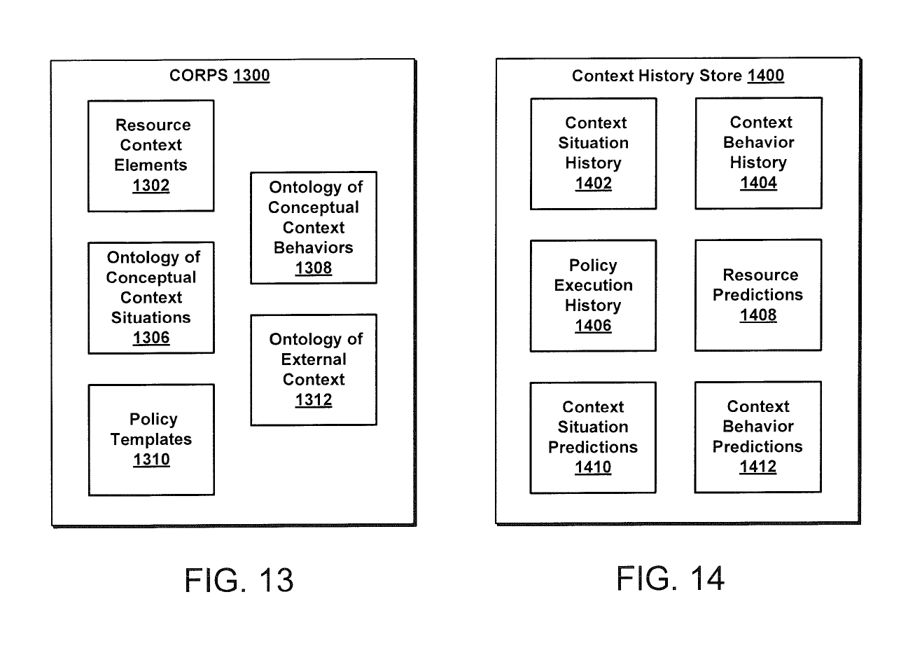

Referring now to FIG. 13, the elements of the CORPS 1300 are detailed. The CORPS 1070 is the Context Ontology with Resource and Policy Semantics repository. The CORPS 1300 contains knowledge about resources, their characteristics, the kinds and ranges of measurements that they can make, rules for how to transform resource raw data to low-level or high-level contextual information, templates for possible policies regarding data security, privacy, resource usage, or context adaptation for applications, operating system components, or resources.

Specifically, the resource context elements 1302 contain information about how to transform or process resource raw data 802 from low level data into high level context data. The resource context elements can contain references to specific methods contained within the context manager 1060 for performing the processing, or to external methods or services for doing same, or can be self-contained mapping rules from low level data onto high level context information.

The ontology of conceptual context situations 1306 is a lattice of nodes representing context situations, with each context situation node containing various properties for high level resource context elements. When higher level context situations are composed of lower level context situations, then properties may include values from constituent context situation's properties, or processed combinations of such values. A higher level context situation encompasses a time interval for its context situation that substantially overlaps the time intervals for its constituent context situations. If there is no overlap, but rather a sequence, then a combination of such situations is termed a type of context behavior rather than a higher level context situation.

In one embodiment, conceptual context situations 1306 are manually authored into the CORPS 1300 as a form of expert knowledge.

In another embodiment, conceptual context situations 1306 are automatically entered into the CORPS 1300 using a hierarchical clustering method that creates a dendrogram over combinations of resource context elements 1302. Each level of cluster is a context situation. In another embodiment a plurality of different hierarchical clustering methods can be employed yielding not a single hierarchical dendrogram, but rather a lattice.

In another embodiment, conceptual context situations 1306 are created by looking at the complete set of all possible combinations of resource context elements 1302. This is potentially a very large number of situations. The context manager 1060 may construct such conceptual context situations and promote them into the CORPS 1300 based on the history of context situations within the context history store 1062 that occur frequently or represent discovered association rules with high support and confidence.

In another embodiment, either of the two previous methods can be used looking not just at combinations of resource context elements 1302 but also other lower level conceptual context situations 1306.

The ontology of conceptual context behaviors 1308 can be constructed in similar manner to how conceptual context situations 1306 are created, either by manual authoring or by automated procedures within the context manager 1060 or the context knowledge discovery manager 1064. A context behavior is an ordered sequence or an unordered collection of context situations or other context behaviors which substantially overlap with the time duration of the context behavior. Typically the constituent context situations or other behaviors both begin and end during the time interval of the containing context behavior. But a constituent context situation or other context behavior may begin prior to the beginning of the context behavior as long as it ends after the containing context behavior begins. Likewise, a constituent context situation or other context behavior may begin prior to the end of the containing context behavior but may end after the end of the containing context behavior.

An example of a higher level context situation is MORNING-AT-WORK. The AT-WORKPLACE-LOCATION context situation may involve only location-related resource context elements that indicate that the user and device are physically at the user's workplace location. The MORNING context situation may involve only time-related resource context elements that indicate that the time is in the range from 8 a.m. until 10 a.m. The MORNING-AT-WORK situation can be defined as the combination of the AT-WORKPLACE-LOCATION and MORNING context situations.

In one embodiment the rules for processing a resource context element 1302 or for property values for a context situation can be defined as a type I fuzzy set. In the example above for clock time, the fuzzy set definition for the time property for the MORNING situation could be a trapezoidal fuzzy definition MORNING fuzzy set 1600 as shown in FIG. 16. In another embodiment the rule could use a type II fuzzy set.

In another embodiment there can be multiple mobile devices 600, either for the same user in communication with the server/cloud context management service 1050. In this case there can be context situations and context behaviors defined using information from a plurality of the mobile devices 600 for the same user. These devices could include smart phones, tablets, or PCs, among others. There may be context information available from one such device that could aid in the contextual management of another such device.

In another embodiment there can be context situations or context behaviors defined using information from a collection of a plurality of mobile devices from a plurality of users. These devices may share a common piece of hardware, or a common current location, or have the same application installed. This can especially be valuable for use in the context history store 1062 in conjunction with the operations of the context knowledge discovery manager 1064.

A policy template 1310 in the CORPS 1300 is policy constructed with respect to context situations or context behaviors in the CORPS 1300. A policy can be enabled by a link to a particular context situation or context behavior. When such a context situation or context behavior is active, the link indicates that the linked policy is to be used for context management on the mobile device. A policy template 1310 can be expressed in a number of ways.

In one embodiment a policy template is a set of IF-THEN-ELSE rules which test properties or relationships of the current context situation and take actions which can involve modifying the settings or configurations or current state of applications or the operating system or resources on the mobile device 600, or modifying the settings or configurations or current state of other elements of the environment that are external to the mobile device 600.

Other actions can involve sending notifications to the current user on the same or a different device, or executing a named procedure from the policy manager to solicit user input or approval for a tentative decision to take a particular action. Such notifications could be an informational message to the user that the active context policy manger has taken an action, or could be a request for the user's permission to take an action, or could be a recommendation to the user that the user take a particular action.

In another embodiment a policy could be a piece of source code or executable code to be run on the device in the context of the device's active context policy manager. In another embodiment a policy could be a set of desired states or configuration settings. In another embodiment a policy could be a set of rules to be enforced on the device by the active context policy manager; for example, the rules could involve which applications are allowed to execute, permissible settings for applications, permissible sensors to be read, or files or databases to be read from or written to, permissible network technologies or network destinations, or types of content allowed to be read from or transmitted away from the device. Policy templates can have a purpose related to resource usage on the device, or related to security or privacy considerations. A policy template 1310 is called a template because it may contain slots that can be filled by values from designated properties from the associated context situation or context behavior.

The ontology of external context 1312 is an ontology of concepts that support reasoning about context elements, context situations, and context behaviors. Properties for nodes are things that are useful in reasoning about context, making distinctions, or in seeking out additional information to enhance existing context information. Relationships for nodes may include “is-a” relationships (hypernymy, hyponomy), “part-of” relationships (meronymy), or other special purpose relationships. Thus the ontology of external context 1312 is an ontology of the world (the parts of the world that are useful to be modeled for context interpretation and enhancement) and of services for context enrichment.

For example, one piece of context information could be the global positioning system (GPS) coordinates of the mobile device's current location expressed as latitude and longitude: 41.767575, −88.070217. The ontology of external context 1312 has a concept node for GPS-COORDINATE. One of the properties for this node is the information about an external service that provides enhanced context information when given a GPS coordinate. An example of enhanced information returned is an address corresponding to the GPS coordinates, and the name of the business or building at that location. In this example, the service returns the information “Cinemark At Seven Bridges IMAX, 6500 Illinois 53, Woodridge, Ill.; (630) 663-8892; cinemark.com” for the given GPS coordinates. The information returned by a context-enhancement service could be in natural language text, or could be in structured data, e.g., {businessName: “Cinemark At Seven Bridges IMAX”, address: “6500 Illinois 53, Woodridge, Ill.”, phone: “(630) 663-8892”, website: “cinemark.com”}.

Another context-enhancement service registered as a value of the BUSINESS-CATEGORY-SERVICE property of the concept node labeled BUSINESS could be called with the information returned from the previous context-enhancement service call to obtain the business category “MOVIE-THEATER”. There is a corresponding concept node in the ontology MOVIE-THEATER, inheriting properties from its parent concept node PERFORMANCE-VENUE, which has several properties. One property is a link to a policy template that was written to handle the actions that a user would normally take in a performance venue, namely, to turn the phone ringer from normal ring to vibrate, and to turn off Wi-Fi and GPS services to conserve battery.

The knowledge in the ontology of external context 1312 permits the system to understand more about the user and device's current context, and to obtain additional information to enhance that understanding. This enables policy actions such as automatically adjusting phone ringer settings and turning off certain network services to conserve battery upon the user entering a movie theater, and to restore those settings upon exiting the theater.

In another embodiment the ontology of external context 1312 may contain information about certain external context services which are themselves only available and relevant in certain situations. For example, a user and the user's mobile device are in the AT-HOME situation. The user has a television which is equipped with an external context service that communicates via Wi-Fi or Bluetooth or other networking technology and provides programming information about which television channel is currently being displayed on the television. This external content service can be used to obtain that information and to enrich the context with the expected duration of the program being viewed, or to enable applications that are aware of the context management infrastructure to supply so-called second screen added functionality (the term second-screen refers to a simultaneous although not necessarily coordinated use of a mobile or other computing device while the user is attending to a broadcast or playback or on-demand display of an event on a television).

Additional context enrichment information about what content was being presented on those channels (show episode descriptions, episode identifiers, CCTV text transcripts of voice audio on the shows, actual audio and/or images shown), and information about which related content was shown (promos, advertisements, etc.) can be used by second screen applications to adapt to context, e.g., by serving other content or advertising related to the content, or by connecting to social media channels related to the content.

Turning now to FIG. 14, the details of the context history store 1400 are shown. The context situation history 1402 is a history of substantially every occurrence of each context situation that has occurred on the mobile device 600. Each occurrence is timestamped with the beginning and end of the context situation. The properties of each context situation instance are filled with the values that existed at the time of the occurrence. In one embodiment the older occurrences of context situations may be purged either periodically, or upon request, or substantially similar context situations may be summarized or counted, or based on space available for the storage of the context situation history.

In some cases a property value in the context situation history 1402 is itself multi-valued, a time series of the different values of the property's value during the life of the situation.

One purpose of tracking context situation history 1402 is to be able to identify frequently occurring context situations that represent an opportunity for manually or programmatically authoring new or modified policy templates to deal with the context situation.

Another purpose in tracking context situation history 1402 is to allow various data mining activities of the context knowledge discovery manager 1.064 to find clusters or patterns for creating new higher level context situation or context behavior definitions into the CORPS 1070 or to discover association rules with high confidence and support that can be used for predicting resource usage during context situations (context situation predictions 1410 or contributions to resource predictions 1408), or for predicting ordered sequences of context situations or unordered collections of co-occurring situations that can constitute a new context behavior definition to be promoted into the CORPS 1070.

Context behavior history 1404 is similar to context situation history 1402 except that it deals with the processing of historical occurrences of context behaviors.

Policy execution history 1406 is tracked not just for audit and reporting purposes, but also includes tracking of the results and effectiveness of policy execution, especially in terms of resources conserved by active context management. This information is also an input to the context knowledge discovery manager 1064 and to the active context policy manager 1080 or 1020 to assist in the evaluation of existing policies and the generation of new policies.

Resource predictions 1408 are constructed and written to the context history store 1062 by the context knowledge discovery manager 1064, and are based on aggregate statistics across context situation histories for a user's mobile device. A resource prediction 1408 is a prediction of what is likely to happen with respect to a resource over time. This can include expected rates of resource usage, usual network locations contacted, usual applications executed, and frequency of certain activities performed on the mobile device 600 by applications 602 or the operating system 604 or resources 606. These can be important in context management when novel situations are encountered.

Context situation predictions 1410 are predictions of what happens within the duration of a context situation. This can include expected rates of resource usage, usual network locations contacted, and usual applications executed, among other things.

Context behavior predictions 1412 are predictions regarding sequences of constituent context situation transitions, or frequencies of co-occurrence of unordered collections of constituent context situations. Context behavior predictions in high level context behaviors are useful for characterizing such things as the typical workday lifecycle. An important part of prediction is a glide path for resource utilization with respect to a large time granularity context behavior. Context behavior history provides predictions of resource usage when the user is in a particular context behavior; if a user is currently using more resource than typical for a given context behavior (below the glide path) it can be a trigger point for a policy to enforce stricter resource conservation efforts, either automatically, or with the informed consent of the user.

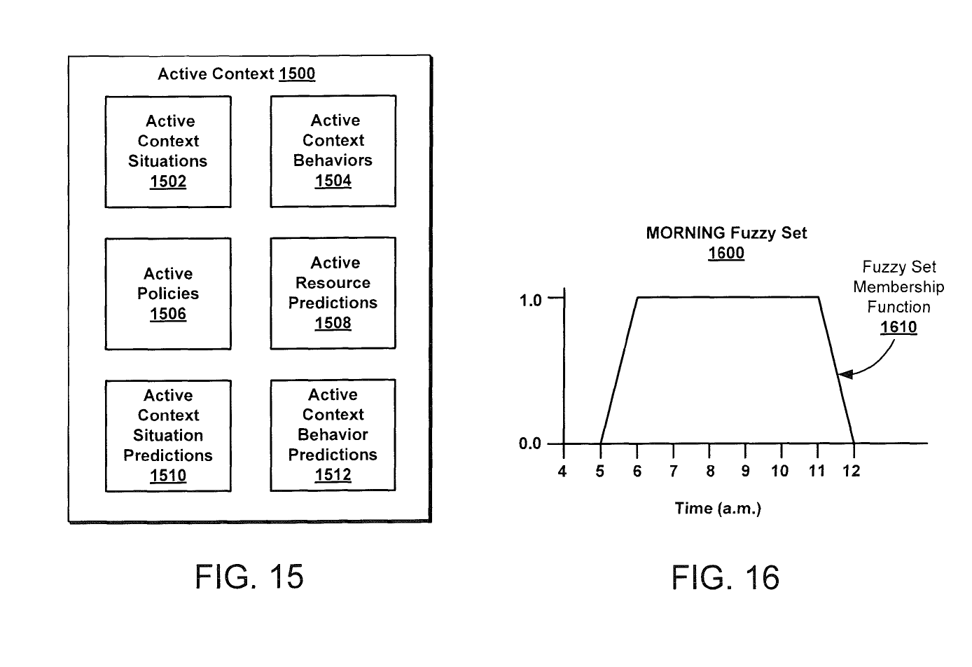

Referring now to FIG. 15, the details of the active context 1500 are illustrated. The active context 1500 refers to either the active context 1066 which resides in the server/cloud context management service 1050 or the active context 1022 which resides in the mobile device 100. The context manager 1060 is responsible for placing context situations, context behaviors, policies, resource predictions, context situation predictions, and context behavior predictions into the active context 1022, based on the information in the activity store 154 and the CORPS 1070.

Active context situations 1502 are the specific instantiations of conceptual context situations, corresponding to context situations that are currently occurring. An active context situation 1502 is a conceptual context situation structure, with values for properties that correspond to the current state of the context elements derived from resources, applications, or the operating system on a particular mobile device, or of the context elements associated with the external environment of the device, and of any other constituent active context situations 1502.

An active context situation 1502 is marked as active when it is placed into the active context 1500; and when such a context situation ends, it is marked as inactive and may be removed from the active context 1500. In an embodiment, an active context situation 1502 marked as inactive is allowed to remain in the active context 1500 for a configurable amount of time before being removed, or to facilitate processing related to active context behaviors 1504.

Active context situations 1502 which are higher level context situations comprising multiple other context situations are linked together in the active context 1500.

Multiple context situations related to a user or a mobile device 600 can be active at a single point in time.

Active context behaviors 1504 are the specific instantiations of conceptual context behaviors, corresponding to context behaviors that are currently occurring. An active context behavior 1504 is a conceptual context behavior structure, with values for properties that correspond to the current state of the context elements derived from resources, applications, or the operating system on a particular mobile device, and of the context elements derived from the external environment of the device, and of any other constituent active context situations 1502 or active context behaviors 1504.

An active context behavior 1504 is marked as active when it is placed into the active context 1500; and when such a context behavior ends, it is marked as inactive and may be removed from the active context 1500. In an embodiment, an active context behavior 1504 marked as inactive is allowed to remain in the active context 1500 for a configurable amount of time before being removed, or to facilitate processing related to other parent active context behaviors 1504, and because the very definition of a context behavior may be such that it is only the passing of time without the occurrence of potentially constituent situations that defines the end of the context behavior.

Active context behaviors 1504 which are higher level context behaviors comprising multiple other context behaviors are linked together in the active context 1000.

Active policies 1506 are policies that are currently enabled for running on the mobile device 600, controlled by the device's active context policy manager 1020. An active policy is linked to one or more active context situations 1502 or active context behaviors 1504. The active context policy manager 1080 running on the server/cloud context management service 1050 communicates active policies 1506 from the active context 1066 to the active context policy manager 1020 running on the mobile device 600, where they are in turn stored in the device-side active context 1022.

Active resource predictions 1508 are resource predictions 1408 taken from the context history store 1400 when the mobile device 600 being managed has the applicable resources on it. These resource predictions are aggregate ones that can be used when novel situations or behaviors are encountered that do not have associated situation predictions or behavior predictions.

Active context situation predictions 1510 are placed into the active context 1066 by the context manager 1060 when a corresponding active context situation has been placed into the active context 1066.

Active context behavior predictions 1512 are placed into the active context 1066 by the context manager 1060 when a corresponding active context behavior has been placed into the active context 1066.

Referring now to FIG. 16, an illustration is made of the MORNING Fuzzy Set 1600, which is an example of how a resource context element 1302 can be processed from raw, low level data into a higher level representation. The fuzzy set membership function 1610 represents how a resource context element for time of day corresponds to the higher level context representation MORNING. This is standard type I fuzzy set technology. In an embodiment type II fuzzy sets can also be used.

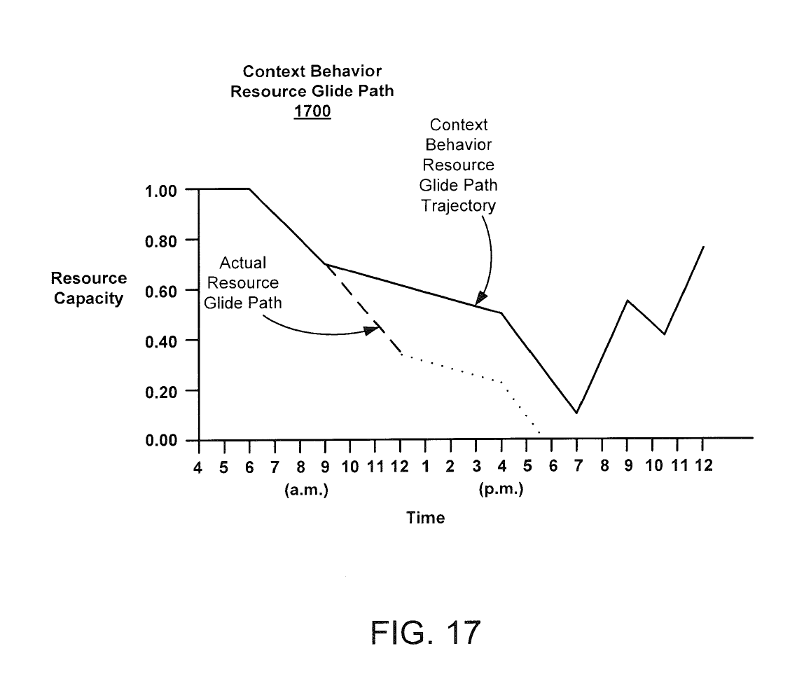

Turning now to FIG. 17, an example context behavior resource glide path 1700 is detailed. The context behavior resource glide path is a property of a context behavior prediction. There can be multiple context behavior predictions that are active at any point in time; these may have an associated estimated probability or likelihood.

One such context behavior prediction could be designated as the best case prediction, where best case means in terms of minimal resource usage. Another such context behavior prediction could be designated the worst case prediction, where worst case means in terms of the largest expected resource usage. Another such context behavior prediction could be designated as the most likely case prediction, where most likely case is based on the statistical analysis of historical context behaviors. There can be different context behavior glide path properties for different resources 606 that exist on the mobile device 600.

In an embodiment the context manager 1060 can observe additional context information related to planned future events (such as calendar appointments) and use that information to modify a behavior prediction and its associated behavior resource glide path. For example, a future calendar appointment may indicate that the user's time away from the HOME context situation (where there known to be a battery charger available) may be extended, and to adjust the context behavior resource glide path accordingly. In this embodiment, a special type of active context situation 1502 can be entered into the active context 1066, representing a planned future context situation. This could lead to the creation of a new context behavior that encompasses the existing WORKDAY context behavior, and contains the modified context behavior resource glide path.

In another embodiment the context manager 1060 can take into account user or administrator provided context information related to potential future events (such as phone calls) and use that information to modify a context behavior prediction and its associated context behavior resource glide path.

For example, a parent who is an administrator for a child's mobile device may specify that all context behavior planning needs to plan for having enough resources to make an emergency phone call, even though that occurrence may not occur frequently or ever in context behavior history. The emergency reserve for a specific number of specific types of resource consuming actions adjusts the context behavior resource glide path property of the context behavior, effectively raising the floor to which the policy manager will ever allow the resource capacity to fall before taking a mitigation action. There is an advantage in terms of either specifying types of reserves or in a user's understanding of reserve provisions in a policy to being able to express them with respect to higher level user actions (such as “make a phone call”) versus lower level resource specific criteria (such as “maintain at least 8 percent battery charge”).

An example of a policy's mitigation actions is when the active context policy manager, understanding that there is barely enough battery capacity left to make an emergency phone call, shuts off all other services on the phone (including music player applications, SMS texting, Wi-Fi network connections, and game applications), and notifies the child user what has happened and why.

Policy templates stored in the CORPS can be viewed and edited by suitably authorized users or other designated policy administrators, by on-device user interfaces controlled by the active context policy manager 1020 or via web user interfaces controlled by the active context policy manager 1080. An advantage of this system is that it enables the composition and simultaneous enforcement of policies from administrators and users in a manner consistent with the aims of both and enables a consistent approach to resource and policy management across all apps whether they are aware of the context management infrastructure or not. It also allows for the contextual enforcement of security and privacy policies regarding the access to or use of context information.

In another embodiment the active context policy manager 1080 can take advantage of the fact that the server/cloud context management service 1050 manages context and policies for very many devices used by many users. In this embodiment the active context policy manager 1080 can use evolutionary computation/genetic algorithm techniques to explore the space of possible policy variants in search of optimal effectiveness.

When a context situation or context behavior is observed in the context history store 1062 to be common across many devices and users by the active context policy manager 1080, the policy manager can choose to generate several possible policy templates 1310 for the same situation, using the usual genetic algorithm techniques of mutation and crossover operators. The active context policy manager 1080 can select different variations of a policy for deployment into the active context 1066 for different devices or users.

Subsequent analysis of the effectiveness of each policy using the policy execution history 1406 in the context history store 1400 with respect to resource conservation or other metrics provides the evaluation function/fitness function that genetic algorithms use to further evolve variations on solutions. Successful policies can then be evolved in another generation. In this embodiment the policies for all users become more effective over time because of the ongoing optimization process involved in generating policy variants. Examples of policy variations can include adjusting resource settings earlier or later, or using resource settings that are more or less conservative, or using user notifications instead of taking direct actions by the policy manager.

Some examples of the many items of activity information, which are related to resources, applications, or the operating system on a mobile device, that an activity monitor can collect are listed below:

Current state of device or components or applications or other connected devices:
Current system reported battery level (0 percent to 100 percent) for each battery currently connected
Current settings of battery (including battery saver or performance modes) for each battery currently connected
Current state of battery charging (e.g., currently being charged by a battery charger or other external power source, or not currently being charged) for each battery currently connected
Current power availability state of any external power source connected to device but not being used for battery charging, such as external battery, fuel cell, solar cell, or other power source, measured in mAh (milli Amp hours) or in Wh (Watt hours)
Current other internal state of any external power source connected to device, such as external battery level, fuel cell current butane level, solar cell measured ambient light level, current power level being generated by mechanical means (e.g., power harvesting technology from walking or bicycling or other user motion using piezoelectric or other devices), or other power sources,
System reported battery level (0 percent to 100 percent) at the time of power-related events for each battery currently connected; power-related events include among other things the beginning of a battery charging event, the end of a battery charging event, a device power on event, a device power off event, a detection of a switch in battery identifier,
System reported battery level (0 percent to 100 percent) at the time of power-related events for each battery currently connected
Time elapsed since various power-related events for each battery currently connected
Measured battery charging during last charging event (e.g., measured in mAh (milli Amp hours) or in Wh (Watt hours) or by Coulomb counting or other methods) for each battery currently connected
Measured battery usage since last charging event or device power on event (e.g., measured in mAh (milli Amp hours) or in Wh (Watt hours) or by Coulomb counting or other methods) for each battery currently connected
Identification of battery or battery type or model for each battery currently or previously connected
Elapsed time since manufacture of battery (age of battery) for each battery currently or previously connected
Elapsed total time battery has been on while not charging, for each battery currently or previously connected, since the manufacture of battery or since the last charging event or since the last device power on event
Elapsed total time battery has been on while charging, for each battery currently or previously connected, since the manufacture of battery or since the last charging event or since the last device power on event
Number of charging events for battery, for each battery currently or previously connected
Current operational status of battery charging capability, i.e., able to charge using external power source, or unable to charge (e.g., due to charging system failure) for each battery currently or previously connected
Current internal device temperature, humidity, or moisture levels; this includes sensor values for the device itself and for device components such as processors
Current external or ambient temperature or humidity; this includes external or ambient values from sensors on the device, as well as inferred external temperatures using device location and temperature or humidity values for weather stations nearby the device location
Average, minimum, and maximum internal device-related temperatures since the occurrence of various power-related events
Average, minimum, and maximum external or ambient temperatures since the occurrence of various power-related events
Current power draw by device (e.g., measured in mAh (milli Amp hours) or in Wh (Watt hours) or by Coulomb counting or other methods)
Identification of each CPU or associated or auxiliary processor (such as GPUs or cryptographic processors), or processor type or model for each processor that is part of or attached to the device
Elapsed CPU time since last power on event or last charging event, for each CPU in device (including any associated processors such as GPUs or cryptographic processors)
Normal rated frequency of operation for each processor that is part of or attached to the device (including any associated processors such as GPUs or cryptographic processors)
Current operating frequency of operation for each processor that is part of or attached to the device (including any associated processors such as GPUs or cryptographic processors)
Currently activated CPU power preserving modes for each processor that is part of or attached to the device (such as Intel SpeedStep or AMD PowerNow!)
Potentially available CPU power preserving modes for each processor that is part of or attached to the device (such as Intel SpeedStep or AMD PowerNow!)
Identification of communication devices or components, or type of communications device or component (such as radios, Wi-Fi, GPS, Bluetooth, NFC, GSM, CDMA, 3G, LTE, 2G, and others, or for optical communications such as infrared or visible light communications, or for audio communication such as powering internal or external speakers or microphones, or for quantum communications), or model for each communication device or component that is part of or connected to the device,
Current external communication state (such as on or off or in any of several operating modes such as standby, power-preserving mode) and settings, such as signal strength, elapsed time communication has been used, measured power consumption for communication, for each communication type and technology, such as for radiofrequency communications such as Wi-Fi, GPS, Bluetooth, NFC, GSM, CDMA, 3G, LTE, 2G, and others, or for optical communications such as infrared or visible light communications, or for audio communication such as powering internal or external speakers or microphones, or for quantum communications, and which communications protocols have been in use, and measurements of the amount of communication such as bytes sent, bytes received, number of communications initiated or responded to.
Identification of display(s) or display type (e.g. LCD or OLED or electronic ink, or projection display, among others) or model for each display that is part of or connected to the device,
Current display settings (including brightness level, auto-brightness setting, positive vs. negative mode, contrast level) for each display that is part of or connected to the device,
Elapsed time that each display has been on, since last charging event end or most recent device power on event, for each display that is part of or connected to the device
Measured energy usage since last charging event end or most recent device power on event, for each display that is part of or connected to the device
Identification of audio output or input devices or type or model for each audio output or input device that is part of or connected to the device
Current audio output or input settings (including volume level, microphone sensitivity) for each audio output or input device that is part of or connected to the device
Elapsed time that each audio output or input device has been on since last charging event or device power on event or other time or event, for each audio output or input device that is part of or connected to the device
Measured energy usage since last charging event end or most recent device power on event, for each audio output or input device that is part of or connected to the device
Identification of sensors (such as accelerometers, compasses, temperature sensors, barometric pressure sensors, altitude sensors, humidity sensors, moisture sensors, touch or pressure sensors, orientation sensors, cameras, scanning devices, proximity sensors, gyroscopes, ambient light sensors, chemical or odor sensors, biometric input sensors, or medically related sensors such as heartbeat, respiration, blood pressure, blood oxygen levels using for example pulse oximetry, EEG sensors including low level frequency and amplitude measurements or derived information regarding the presence or strength of wave patterns such as Delta, Theta, Alpha, Beta, Gamma, or Mu, or tDCS or TMS sensors or ECG sensors) or sensors related to a device user's gaze direction or sensor types or models for each sensor that is part of or connected to the device
Current sensor state (on, off, performance mode) and settings for each sensor that is part of or connected to the device
Elapsed time that each sensor has been on since last charging event or device power on event, for each sensor that is part of or connected to the device
Measured energy usage since last charging event end or most recent device power on event, for each sensor that is part of or connected to the device
Identification of which apps or services or operating system components are installed on the device or on removable media connected to the device or may be running on the device, including app name, version, app vendor name, digital signature with which the app may be signed
Current app or service or operating system components state (running, quiescent, not running) and settings, for each such item that is installed on the device or on removable media connected to the device or may be running on the device
Elapsed time that each app or service or operating system component has been running since last charging event or device power on event, for each such item that is installed on the device or on removable media connected to the device or may be running on the device
Elapsed CPU time or network usage time for each app or service or operating system component since last charging event or device power on event, for each such item that is installed on the device or on removable media connected to the device or may be running on the device
Measured energy usage for each app or service or operating system component since last charging event or device power on event, for each such item that is installed on the device or on removable media connected to the device or may be running on the device
Current location of device (to be correlated with usage history for presence or availability of charging devices)
Identification of the data or other communication limits for the device such as monthly data usage limits.
Measurement of the data or other communication quantities since the beginning of the accounting period for measuring such quantities, or since the last charging event, or since the last power on event, or other power-related events, including such items as the number of communications initiated or responded to, the number of bytes sent or received, elapsed time for communications, measured CPU usage or power usage for the communications, the communications technology or component or device used, the protocols used.
Demographic information about the users of the device, including but not limited to age, gender, occupation, hobbies, years of education, and so on, and which user is the currently active user of the device.
The current and recent history of whether airplane mode has been turned on or off, or regarding the settings and switching of other profiles.
The current device autolock time interval or time interval for turning device display off; elapsed times spent in locked and unlocked states, the number of autolock or manual lock and unlock events.
Identification of SIM cards currently or recently used in the mobile device.
Information about any applications which are holding any type of operating system lock, for example, a wake lock.
Information about the occurrence of user level events (the things that users do or observe, as opposed to events that relate to the inner workings of parts of a mobile device. Examples include the number and size of text messages sent and their destination or received and their source; the number and length of music songs or voice podcasts listened to, and their source (local device storage or from a specific network source, played by which applications); the number and length of communications sent at the network level (packets, bytes sent/received); the number and duration and connected numbers of inbound or outbound voice phone calls; information about which communication base stations have been observed, their identifiers and technology used and signal strength, including cell towers, Wi-Fi base stations, and so on; the number of location requests made, the durations for which location services were turned on and active including GPS or other location services; the number of application related notifications received; the number and identification of apps that have push notifications turned on, the notification refresh rate, the duration of time that push notification has been turned on; settings in email or similar applications regarding push or regarding fetch or polling or synchronization intervals, including what those intervals are and the elapse time spent in each state; the screen brightness settings (e.g., high, low, auto adjustment based on lighting conditions); browser settings, including plugins are related identifying information and settings; settings for the use of a device LED for notifications (on, off, blink, etc.); application level settings and counts for things like tweets, mentions, direct messages, refresh interval, notification on/off, synchronizing twitter data, synchronizing contacts; RSS reader update frequencies; power or signal level settings that a mobile device has used either when conducting communications or when searching for connections such as to cell towers or Wi-Fi stations (this could lead to modeled situations with policies to turn off services while in such areas to conserve battery but to periodically check if a different area with different characteristics has been entered or to switch communications mode from 4G to 3G or from dual mode into a mode that would use less power such as GSM); current audio notification settings such as normal ringer or vibrate or both or silent; the number of movies or videos watched, elapsed time, the source of the material (local or from which network source); the number of times and the timestamps and durations of a phone being put to sleep and awakened; information about all applications and application services, how many times run, elapsed time, resources used; the setting for “setting time zone automatically” (which uses location and location change to auto set the time zone for device but uses power to do so); which ringtones are in use and the ringtone volume level and average RMS level; whether a phone is rooted or not and the timestamp when it happened; current calendar status (in a meeting, text content, location tag for meeting), the time start and stop for it; and for other items on the calendar for today (prior and upcoming); count and duration of times when the mobile device was being used for Wi-Fi tethering; the amount of CPU, network usage, and battery related to the receiving and presenting advertisements and counts of such events, together with information regarding which application and ad network was used to mediate the receipt and presentation;

The activity store 654 can store any of the things collected by the activity monitor. In an embodiment it can also collect various histories and statistics regarding any of those items. Examples of these items include:
Minimum, maximum, average battery usage, and other information related to the historical or statistical distribution of battery usage, such as standard deviation of measured battery usage, in aggregate or broken out by time of day, or by day of week, or by type of day (workday, weekend, holiday), or by location or location category (e.g., home, work, commuting, etc.), or by app or service or operating system component, or by communications device or processor or sensor, or combination thereof.
Historical or statistical information regarding the times of regular charging events, in aggregate or broken out by time of day, or by day of week, or by type of day (workday, weekend, holiday), or by location or location category (e.g., home, work, commuting, etc.)
Historical or statistical information regarding location categories, e.g., clusters of time and location dwell times, such as the location of home, of work, of commuting, or other clusters which may or may not have an associated user label or category
Historical or statistical information regarding the time and/or location of the end of day event or arrival or departure from any of the labeled or unlabeled location categories
Historical or statistical information regarding the time, location, and duration of battery charging events or external power supply events or arrival or departure from any of the labeled or unlabeled location categories at which charging events or external power supply events have occurred, and information regarding the type of battery charging operation or external power supply operation which occurred (e.g., including the type, model, settings, and usage of battery charger or external power supply, or fuel cell, solar cell, mechanical power-generating means or other power sources)
Historical or statistical information regarding the reported battery levels at the beginning and end of each battery charging event or device power on event for each battery that has ever been connected to the device
Historical or statistical information regarding the reported battery levels broken out by location or location category or time of day or day of week or combination thereof for each battery that has ever been connected to the device
Historical or statistical information regarding occurrences when battery levels have dropped to zero or below established thresholds, broken out by location or location category or time of day or day of week or combination thereof for each battery that has ever been connected to the device
Historical or statistical information regarding battery charging measurements made during charging events (e.g., measured in mAh (milli Amp hours) or in Wh (Watt hours) or by Coulomb counting) for each battery that has ever been connected to the device
Historical or statistical information regarding battery usage during intervals between charging events and/or device power on events, measured in mAh (milli Amp hours) or in Wh (Watt hours) or by Coulomb counting) for each battery that has ever been connected to the device
Historical information regarding the identification of battery or battery type or model for each battery ever connected
Historical information regarding the elapsed time since manufacture of battery (age of battery) for each battery that has ever been connected to the device
Historical or statistical information regarding the elapsed total time battery has been on while not charging, for each battery that has ever been connected to the device, cumulative since the manufacture of battery or for each interval between charging events or device power on events
Historical or statistical information regarding the elapsed total time battery has been on while charging, for each battery that has ever been connected to the device, cumulative since the manufacture of battery or for each interval between charging events or device power on events
Historical or statistical information regarding the number of charging events for each battery that has ever been connected to the device
Historical record of every occurrence of a change in the current operational status of battery charging capability, i.e., able to charge using external power source, or unable to charge (e.g., due to charging system failure) for each battery that has ever been connected to the device
Historical or statistical information regarding the temperature, humidity, or moisture levels at the device or in device components over time (internal device or device component temperature, humidity, moisture levels, and external or ambient temperature or humidity)
Historical or statistical information regarding the power draw by device over time
Historical or statistical information regarding CPUs or associated or auxiliary processors (such as GPUs or cryptographic processors), including identification of each processor, processor type or model, a time series of the elapsed CPU time over time with power-related events indicated (such as device charging event start, device charging event end, device power off event, device power on event), the actual frequency of operation or any special processor modes related to energy usage such as power preserving modes

Historical or statistical information regarding the identification of communication devices or components, or type of communications device or component (such as radios, Wi-Fi, GPS, Bluetooth, NFC, GSM, CDMA, 3G, LTE, 2G, and others, or for optical communications such as infrared or visible light communications, or for audio communication such as powering internal or external speakers or microphones, or for quantum communications), or model for each communication device or component that is part of or connected to the device or ever has been part of or connected to the device; and historical or statistical information regarding when each of such devices have been operating, on, off, or in any of several operating modes such as standby, power-preserving mode, and using what power, with what signal strength, using what protocols, for what duration, and measurements of the amount of communication such as bytes sent, bytes received, number of communications initiated or responded to.
Historical or statistical information regarding the identification of display(s) or display type (e.g., LCD or OLED or electronic ink, or projection display, among others) or model for each display that is part of or connected to the device or ever has been, the time series information regarding display settings (including brightness level, auto-brightness setting, positive vs. negative mode, contrast level), with power-related events indicated (such as device charging event start, device charging event end, device power off event, device power on event), the amount of time that each display was on, the measured energy usage for each display.
Historical or statistical information regarding the identification of audio output or input devices or types or models for each audio output or input device that is part of or connected to the device or ever has been, and time series information regarding the audio output or input settings (including volume level, microphone sensitivity), with power-related events indicated (such as device charging event start, device charging event end, device power off event, device power on event), the amount of time each audio output or input device was on, and the measured energy usage for each audio output or input device.
Historical or statistical information regarding identification of sensors (such as accelerometers, compasses, temperature sensors, barometric pressure sensors, altitude sensors, humidity sensors, moisture sensors, touch or pressure sensors, orientation sensors, cameras, scanning devices, proximity sensors, gyroscopes, ambient light sensors, chemical or odor sensors, biometric input sensors, or medically related sensors such as heartbeat, respiration, blood pressure, blood oxygen levels using for example pulse oximetry, EEG sensors including low level frequency and amplitude measurements or derived information regarding the presence or strength of wave patterns such as Delta, Theta, Alpha, Beta, Gamma, or Mu, or tDCS or TMS sensors or ECG sensors) or sensors related to a device user's gaze direction or sensor types or models for each sensor that is part of or connected to the device or ever has been, the time series information regarding the sensor state (on, off, performance-saving mode) and settings, with power-related events indicated (such as device charging event start, device charging event end, device power off event, device power on event), the amount of time that each sensor was on, the sensor measurements themselves, and the measured energy usage for each display.
Historical or statistical information regarding the identification of which apps or services or operating system components are installed on the device or on removable media connected to the device or may be running on the device or ever have been, including app name, version, app vendor name, digital signature with which the app may be signed, timestamp for installation, updates, uninstallation, and time series information regarding when each such was running in what state and settings, elapsed time that each such was running, elapsed CPU time or network usage time, measured energy usage with power-related events indicated (such as device charging event start, device charging event end, device power off event, device power on event),
Historical or statistical information regarding the location of the device over time, with power-related events indicated (such as device charging event start, device charging event end, device power off event, device power on event),
Historical or statistical information regarding the data or other communication limits for the device such as monthly data usage limits and time series information on the measurement of the data or other communication quantities since the beginning of the accounting period for measuring such quantities, or since the last charging event, or since the last power on event, or other power-related events, or since the beginning of accounting time periods related to the data usage limits, including such items as the number of communications initiated or responded to, the number of bytes sent or received, elapsed time for communications, measured CPU usage or power usage for the communications, the communications technology or component or device used, the protocols used.
Historical or statistical information about the user(s) of the device, including but not limited to age, gender, occupation, hobbies, years of education, and so on, and time series information about which user has been an active user of the device, with power-related events indicated (such as device charging event start, device charging event end, device power off event, device power on event).
Historical or statistical information about any applications which have held any type of operating system lock, for example, a wake lock, including when the lock was requested, how long the lock was held, and whether the lock was ever relinquished.

Historically measured values related to user behavior and usage of device:
Expected time until end of day
Expected time until next normal charging event
Expected time until device will next be in a location at which charging events have occurred, where location can be an absolute location such as user's home or work, or a relative location such as in the user's car where charging may be possible.

In an embodiment the context knowledge discovery manager 1064 can automatically assign a user-label property to discovered context situations and context behaviors. When meaningful labels can be generated automatically for context situations and context behaviors it is easier for users and administrators to view information about context situations and context behaviors in the CORPS 1070, context history store 1062, and active contexts 1066 and 1022. A set of heuristics and rules for creating compound user-label values are effective in generation.

E.g., the context situation with the greatest location dwell time during the night, where night is a duration of at least six hours in the same location with no significant activity on the mobile device can usually be labeled HOME. A context situation that has the same location as the HOME context situation and which begins with a period of inactivity of user interaction on the mobile device and terminates with an alarm event can confidently be labeled HOME-SLEEP.

For most users who are of working age, the context situation with the greatest location dwell time during the daytime hours can usually be labeled WORK; for users of school age, such context situations discovered that happen during the school year can usually be labeled SCHOOL.

Repeated geographical behaviors (frequent occurrences of similar motion tracks) can be labeled TRAVEL. When a TRAVEL context behavior begins at the location of the HOME context situation and ends at the location of the WORK context situation, the behavior's user-label can be modified to COMMUTE-HOME-TO-WORK. A TRAVEL context behavior in the other direction can be modified to COMMUTE-WORK-TO-HOME. If the locations on the motion track for the TRAVEL context situation that is part of COMMUTE-HOME-TO-WORK coincide with externally known locations of a public transit line such as BART in the San Francisco area, then the user-label can be further refined to be COMMUTE-HOME-TO-WORK-VIA-BART.

A brief TRAVEL context behavior during the hours that the WORK context situation prevails followed by a short duration at the destination, followed in turn by substantially retracing the original TRAVEL behavior and ending at the WORK context situation location could be labeled ERRAND-FROM-WORK. If an external content service can be employed to identify the name or category of business (e.g., a Staples store in category OFFICE-SUPPLIES-STORE then the label could be refined to ERRAND-FROM-WORK-TO-STAPLES or ERRAND-FROM-WORK-TO-OFFICE-SUPPLIES-STORE.

The advantage in generating such labels automatically is that a user or administrator does not have to assign labels or define context situations and context behaviors; these are discovered automatically based on data analysis techniques, clustering techniques, data mining, and heuristics and combining and refining rules for labels. Having labels on context situations and context behaviors makes policy rules more readable and intelligible, and explanations of actions taken by policies more understandable.

In another embodiment the policy manager can make certain context behavior predictions and changes in current behavior available to applications that have chosen to be aware of this context management infrastructure. Such an application can provide enhanced functionality to the user of the mobile device.

One example of such enhanced functionality is for a network enabled music player application, which fetches songs from a network source for play on the mobile device. Such an application, although not active during the currently active context situation or context behavior, may be part of a predicted context behavior. E.g., the AT-WORK context behavior is predicted to end in 30 minutes, and the successor context behavior COMMUTE-HOME-FROM-WORK predicts that the music player application will be used for the duration of that event. Unfortunately for the user, the motion track for the evening commute uses subway tunnels and passes through other areas with poor network connectivity. The application can use the information from the context behavior prediction to know that it can wake up and has 30 minutes to download new music that can then be played to the user during the COMMUTE-HOME-FROM-WORK behavior (during which time it would be unable to download new music due to poor network connectivity). This is an example of context behavior prediction enabled prefetch, or more generally, a context behavior prediction enabled pre-action.

Another example of enhanced functionality using context behavior predictions and context behavior changes is called postfetch, or more generally, a context behavior prediction enabled post-action. A typical scenario for postfetch is when a user wants to perform an activity that requires network connectivity, but the user is currently in a context in which such an activity is going to be slow or expensive or even impossible. When the system detects the user attempting to initiate such an activity while in a network-poor context, the system (or a context management infrastructure aware application) can choose to record the user's intentions (e.g., to perform a particular network search, or to send an email or an SMS text message), and then when the context switches later to one with better network connectivity, to perform the actions as indicated by the user's previously recorded intentions, and then to notify the user that these actions have been completed. In another embodiment the system can simply alert the user that the user's intended action during the current context will be slow or expensive or impossible; the alert can include information about the historical resource usage that is associated with performing the user's intended action.

Another example of enhanced functionality using context behavior predictions and context behavior changes is called contextual substitution. In one embodiment the system, or an application that is aware of the context management infrastructure, can take note of the current context and make a substitution in terms of how services are performed to accommodate the current situation. An example would be a user at work in an interior room of a large office building. In this interior room there is essentially no cell phone network connection due to interference from the building structure, but there is Wi-Fi provisioned throughout the workplace.

In this example, detecting the changed context (no cell connection, but Wi-Fi available), a contextual substitution can take place to route device inbound or outbound phone calls or text messages via the Wi-Fi network rather than through the normal cell connection. This may be accomplished by a combination of actions taken on the device and on external services, directed by the active context policy manager.

For example, outbound phone calls could be directed to use a VoIP application sending call information over the available Wi-Fi network; external services could be invoked to set up call forwarding to a temporary or permanent VoIP phone number which would connect to the user's device over the available Wi-Fi network. Contextual substitution also allows for selection of several alternative methods of provisioning a particular service based on current contextual considerations.

In another embodiment context information can be used for contextual routing of communications or notifications or content in a situation in which a user has multiple devices (e.g., smartphone, tablet, or personal computer (PC)) that are being employed by the user. One aspect of the current active context includes which device to which the user is currently attending. For example, when a device is being interacted with by the user, it is known that the user is attending to a particular device. When a user is interacting with one device, and a different user device is not in the same location, it is known that the different device is not being attended to by the user. A user may be interested in notifications or information that comes into a device that is not currently being attended by the user.

The context management system can route the notification or information to a device to which the user is currently attending. This can be accomplished by the context management system, or can be handled by an application that is aware of the context management system. In one example, a user setting down the user's smartphone on the user's desk while begging to use the user's PC, is actively attending the PC and not the smartphone; when an SMS text message arrives at the smartphone, the context management system (or an application that is aware of the context management system and its context information) can deliver the SMS text message or notification that it was received to the user's PC.

In another example, a user can begin using an internet-based music playing service on the user's smart phone. If the user sets the phone down and picks up the user's tablet and walks away, the same application running on the user's tablet can begin to play the same song at the same point while the smartphone application can stop playing the song.

Another example of a policy in action is where the system has previously observed a rule with high confidence that on Fridays the user does not usually plug in to recharge the device battery until around 3 a.m. On this Friday afternoon the system sees that the battery is at 60 percent capacity and has a prediction that it will not last until 3 a.m. The system's policy alerts and prompts the user to charge the battery now to ensure that adequate battery resource will be available until the expected usual 3 a.m. charging event.

In another embodiment applications that are aware of the context management system can enable more effective context adaptation by informing the active context policy manager before the application takes an action as to what the action would be, including what the configuration parameters would preferentially be from the perspective of the application, and the active context policy manager disapproves the action, or approves the action, or conditionally approves the action with modified configuration parameters.

In another embodiment applications that are unaware of the context management system can become context adaptive by way of the functionality of the context management system. For example, typically applications store their configuration information and settings somewhere on the mobile device, e.g., in a database or in a file in the file system on the device. The active context policy manager can modify the stored configuration information and settings based on an active context policy. The policies can be those that are automatically determined by the context management system, or ones that have been manually specified by the user or an authorized administrator.

There may be different authorization rules for the specification or modification of policies for different administrators or for the user. For example, an enterprise administrator and only an enterprise administrator may be authorized to modify policies that affect the functioning of enterprise applications that are installed on the device; or an enterprise administrator may be able to modify policies for the device as long as the current active context is that the device is physically in the workplace; or the device user may be the only one authorized to modify policies affecting certain personal apps that the user has installed, but the enterprise administrator may be authorized to prevent such apps from running while in certain enterprise contexts. An example of enterprise context is while the device is connected to an enterprise network. Another example of enterprise context is while any enterprise installed app is executing; a sample policy could be that no non-enterprise installed apps can run concurrently with enterprise installed apps, for security and data privacy reasons.

In another embodiment a context management service can use the collective contextual information from a group of users to inform the active context for all such users. For example, all users that are in the same geographical location could be a context group. Communication of the contextual information from the users (and their devices) in the context group could be via their devices' connections to a server/cloud based context management system, or could be a peer to peer communication by active context policy managers on their devices to other devices in the context group.

For some types of context information the sharing of context information among users in the ad hoc, geographical location based context group could be free and unpermissioned; for other types of context information the sharing of context information could require an opt-in permission from the members of the context group, or at least those members whose devices are the source of the shared context information.

Context groups may be formed by the users themselves as needed; for example a context group for a group of friends who are going out for an evening of dining and entertainment. Context groups could be persistent, such as for family members who may wish to share their context information regularly. The availability of shared contextual information from a context group can improve the precision and accuracy of some measurements, or can make available automatic adaptations based on individual active context situations and behaviors. For example, a context group including friends out for an evening's entertainment, if one of the user's device is low on battery, the context group could use contextual substitution to direct incoming voice calls or SMS text messages to the device of one of the other users in the context group who has adequate battery resource.

The act of obtaining or measuring some aspect of context may itself have an impact on context, on various resources; for example, to obtain location context might require the use of GPS or Wi-Fi station presence interrogation which in turn uses network and CPU and battery resources. In one embodiment an active policy can weigh the potential benefits from learning a piece of context information against the mostly known cost of obtaining that piece of context information, and decide whether to obtain the context information or not.

In another embodiment the context management system can use contextual substitution of an alternative source of context information; an example of this would be in a context group including friends out together, it would only be necessary for one user in the context group to have the GPS location system active on that user's device, and the GPS location context information can be shared with the other users and their devices within the context group. The net gain for the context group would be greatly reduced aggregate battery resource. In an embodiment the user whose device is known to do the best job of obtaining GPS location could be the one so designated for use by the context group. In an embodiment the role of which user in a context group is providing a particular type of shared context information can rotate among the different users in the context group, so as to minimize the resource consumption aspect with respect to any individual user in the context group.

The historical context information that is captured in the activity store 654 in the server/cloud management 650 service, or that is captured in the activity store 654 and the context history store 1062 in the server/cloud management 1050 service, can be of great use to application developers, advertising networks, device and device component manufacturers, operating system providers, and communications carriers, for a variety of different reasons.

Such information represents realistic workloads performed by actual users, as well as annotating that information with a rich set of contextual information that provides additional meaning for the interpretation and understanding of this data. In an embodiment the aggregate contextual information that is captured is made available to such consumers of contextual information, either periodically in batch or in substantially real-time. Such aggregate contextual information can be summarized, anonymized, and without any personal identifying information to preserve the privacy of all the users whose contextual information was collected. In particular the overall aggregate contextual information and statistics regarding it, relative to high level context situations and context behaviors would have great value to those data consumers; such information is essentially impossible to obtain today.

In another embodiment the context management system is used to develop, deliver, and enforce policies for devices that are part of what has been called “the internet of things.” In the internet of things there are multiple devices which operate on their own, without accompanying and attendant users. Such devices may be mobile or sessile; they may have various sensors and computing and communication capabilities and may run applications; schematically they can be considered substantially similar to a mobile device 600. “Things” in the internet of things themselves have context information, and can participate in a variety of ways in a context management system, as mobile devices 600 or as external environment resources 630. They can be managed with active context policies. Such “things” may have occasional interactions with their owners or administrators, who may monitor the things or modify settings on these things. Such owners or administrators play the role of users with respect to the “thing” devices as far as the context management system is concerned.

In another embodiment the active context policy manager could enforce a policy that temporarily disables in-application advertising communications during contexts of constrained network bandwidth or battery charge levels.

In another embodiment the active context policy manager could perform a contextual substitution to have in-application advertising communications request purely textual advertisements instead of ones using images or animations (which could use more resources) during contexts of constrained network bandwidth or battery charge levels.

In another embodiment the active context policy manager could perform a contextual substitution to have in-application advertising communications obtain advertisements from an already on-device cache of advertisements instead of obtaining them over a network during contexts of constrained network bandwidth or battery charge levels.

In another embodiment the active context policy manager could provide enriched contextual information to in-application advertising components to permit the connected advertising network to serve ads based on high level context information.

In another embodiment the active context policy manager could be enforcing a policy which restricts the amount of contextual information that an in-application advertising component is allowed to obtain from either the context management system itself or from the device's applications, operating system, or resources; in this embodiment the policy is applied to advertising components of applications, not to applications as a whole, which requires the ability to determine which component of an application a request for context information is coming from.

In an embodiment a context management system communicates with a server/cloud advertising broker, in which context information is sent from the device to the broker, and in which advertisements with contextual conditions are submitted to the broker, and in which the broker matches the current active context information from devices with the contextual conditions submitted with advertisements, and serves the matched advertisements to the device. In this process the broker does not disclose the contextual information to the submitter of the advertisement.

In an embodiment the advertisement may be submitted with not just conditional context information to be matched by the broker, but also with a price the submitter is willing to pay for having the advertisement served; the broker can match devices with advertisements based on the combination of goodness of fit between current context information and the conditional context information submitted with the advertisement, and using information about the price the submitter is willing to pay for having the advertisement served.

In an embodiment the device submits contextual information to the broker with a fee that the user of the device requires to be paid in exchange for viewing an advertisement, and advertisements are submitted with not just conditional context information to be matched by the broker, but also with a price the submitter pis willing to pay for having the advertisement served; the broker can match devices with advertisements based on the combination of goodness of fit between current context information and the conditional context information submitted with the advertisement, and using information about the fee the device user is willing to accept for having the advertisement served, and the price the submitter of the advertisement is willing to pay for having the advertisement served.

In an embodiment the system above may have several “goodness of fit” criteria associated with multiple different fee levels (to be received by a device user) or multiple price levels (to be paid by the submitter of an advertisement). The broker can match devices with advertisements based on all of this information.

In an embodiment the device lock screen displays the current actual and projected resource glide paths, together with information about any actions taken automatically by the system to optimize performance, or actions taken by the system with user's approval, or actions taken directly by the user either based on prompting or independently. Information about active policies is shown. In another embodiment a similar display is available in an application, and the user is able to drill into details or modify policies.

In an embodiment the active state policy manager or the active context policy manager takes the fewest possible number of actions that result in an acceptable resource glide path.

In an embodiment the active state policy manager or active context policy manager detects a user action (for example, launching a game application); the active state policy manager can advise the user how long the user can safely play the game before dropping the resource glide path below acceptable levels.

In an embodiment the current active resource predictions can be presented as notifications in the device notification area. In another embodiment the current active resource predictions can be presented in the user's calendar; a time of predicted resource exhaustion can be shown at that time in the calendar; a time of recommended action (e.g., plug device into charger) can be shown at that time in the calendar.

In an embodiment the system using machine learning can write association rules for sets of actions that are taken by a user when a user enters a particular context situation; the system can prompt the user who is entering a particular context situation or behavior for which there exist high confidence association rules asking if the system should take the set of actions that the user normally takes. In an embodiment the user can specify that such actions should be taken automatically in the future when the user enters that particular context situation or behavior. The message to the user contains the context situation label and description. In an embodiment the set of user actions are represented as a policy, and added as a policy template linked to the particular context situation or behavior.

In an embodiment the system may contain policies intended to preserve contextual privacy by specifying limits on the precision with which the contextual information can be made available to an application or sent off the device, or by specifying limits on the frequency with which contextual information can be requested, or the maximum duration during which contextual information can be requested.

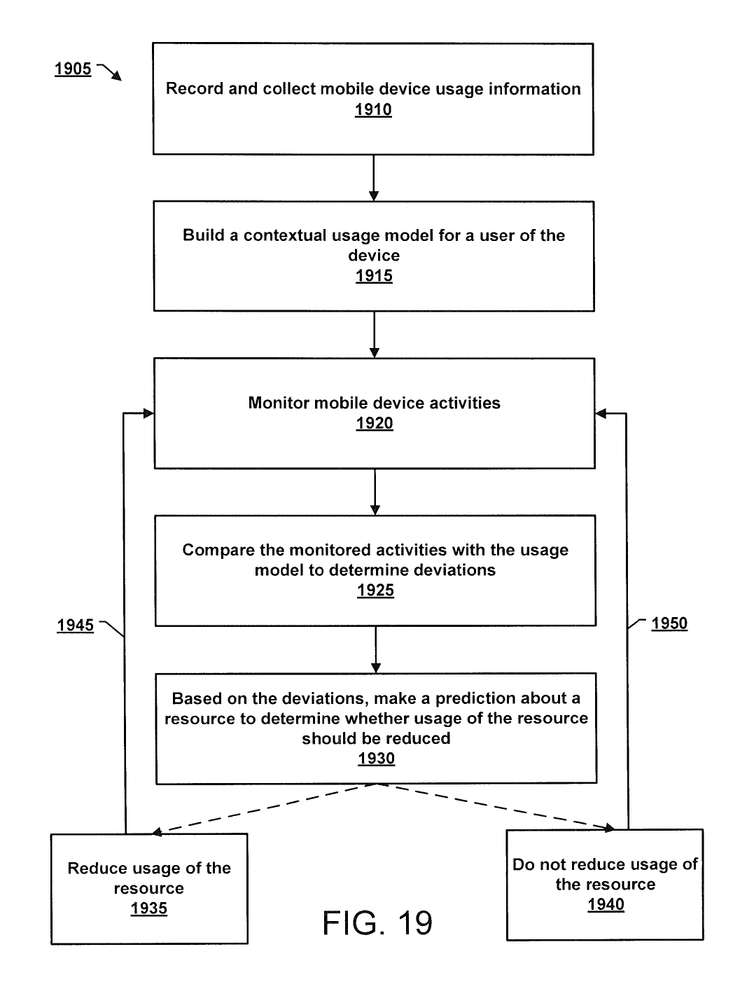

FIG. 19 shows an overall flow 1905 of a specific implementation of the resource prediction system. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular process, application or based on the data.

In a step 1910, the system logs and collects mobile device usage information. The information can include data collected over the course of a day (or less), week, month, or more. For example, data may be collected over a 24-hour period, 48-hour period, 72-hour period, 96-hour period, 120-hour period, 168-hour period, 336-hour period, or 744-hour period.

Data collected over a longer period can provide a more accurate usage model as compared to a usage model based on data collected over a shorter time period. A dataset collected over a shorter time period, however, can be used to more quickly create the usage model. Whether the data is collected over a longer or a shorter period can depend on factors such as the application of the system, desired accuracy, variability in the collected data, and other factors. For example, if a user's schedule and daily activities has a large degree of variability it may take a longer period of time to collect a sufficient amount of data in order to properly model the user's behavior and the various contexts in which the user's mobile device is used. If, however, the user's schedule is fairly routine it can take a shorter period of time to collect the data for the usage model.

Table A below shows an example of some of the historical usage information that may be collected for a particular user.

TABLE A

| | | | Speed |
|---|---|---|---|
| | | Location | (miles |
| Time/Date | Activity | (latitude/longitude) | per hour) |
| October 7, 2011, | No activity detected | 37.789753, | 0 |
| 1:00 AM | | −122.457709 | |
| October 7, 2011, | No activity detected | 37.789753, | 0 |
| 1:10 AM | | −122.457709 | |
| October 7, 2011, | No activity detected | 37.789753, | 0 |
| 1:20 AM | | −122.457709 | |
| . . . | . . . | . . . | . . . |
| October 7, 2011, | No activity detected | 37.789753, | 0 |
| 6:20 AM | | −122.457709 | |
| October 7, 2011, | Movement detected | 37.7911186, | 20 |
| 6:30 AM | | −122.4011706 | |
| . . . | . . . | . . . | . . . |
| October 7, 2011, | Movement detected | 37.790358, | 22 |
| 6:40 AM | | −122.3992305 | |
| October 7, 2011, | No activity detected | 37.7919084, | 0 |
| 6:50 AM | | −122.3986221 | |
| October 7, 2011, | Phone call, no | 37.7919084, | 0 |
| 7:00 AM | movement detected | −122.3986221 | |
| October 7, 2011, | Productivity | 37.7919084, | 0 |
| 7:10 AM | application | −122.3986221 | |
| | executing, no | | |
| | movement detected | | |
| . . . | . . . | . . . | . . . |
| October 7, 2011, | Movement detected | 37.790358, | 15 |
| 5:00 PM | | −122.3992305 | |
| October 7, 2011, | Movement detected | 37.7911186, | 18 |
| 5:10 PM | | −122.4011706 | |
| October 7, 2011, | No activity detected | 37.789753, | 0 |
| 5:20 PM | | −122.457709 | |
| October 7, 2011, | No activity detected | 37.789753, | 0 |
| 5:30 PM | | −122.457709 | |
| . . . | . . . | . . . | . . . |

The entries in Table A above are periodic data samples to track the user's use and nonuse of the mobile device. In this example, the log interval is 10 minutes. The log interval, however, can vary. A shorter log interval can provide a larger dataset for a more accurate model, but will consume more resources (e.g., storage and battery power). A longer log interval will provide a smaller dataset, but will help to conserve resources. The log interval can be configurable such as by a user or system administrator.

As shown in Table A above, each entry may include contextual information such as a time and date stamp, a description of the activity detected, a location of the mobile device at the time of the detection, and a speed of the mobile device at the time of detection.

In a step 1915, a contextual usage model for a user of the mobile device is built using the collected information. In a specific implementation, the contextual usage model is created by analyzing the data for patterns. The patterns can be tagged or associated with a context label or category from the context ontology. Some examples of pattern matching include searching the log data for groups of consecutive entries where no activity, movement, or both are detected, and searching entries where activity, movement, or both are detected.

Patterns may be identified by comparing and correlating data collected during one time period with data collected during another or corresponding time period. The time period can be of any duration, can be during any part of the day (e.g., morning, afternoon, or evening), and can be during any part of the year (e.g., fall, winter, spring, or summer).

As an example, data collected during a weekday context may be compared with data collected during another weekday context to determine expected use of the device on a weekday. Data collected on a weekend context may be compared with data collected on another weekend context to determine expected use on a weekend. Data collected on the weekend context may be compared with data collected on a weekday context to determine differences in expected use during weekends versus weekdays. Data collected on, for example, a Monday, may be compared with data collected on a different Monday to determine expected use on Mondays. The data may be cross-referenced to other sources of information. For example, location or GPS coordinate data may be cross-referenced against a database that maps GPS coordinates to a street address or zip code.

Identifying contexts to include in the model can be based on the frequency that the context occurs. Contexts that occur frequently may be included in the model. Contexts that do not occur frequently may be excluded or omitted from the model.

Table B below shows a subset of consecutive entries from Table A where no activity and movement was detected.

TABLE B

| | | Location | Speed |
|---|---|---|---|
| | | (latitude/ | (miles per |
| Time/Date | Activity | longitude) | hour) |
| October 7, 2011, | No activity detected | 37.789753, | 0 |
| 1:00 AM | | −122.457709 | |
| October 7, 2011, | No activity detected | 37.789753, | 0 |
| 1:10 AM | | −122.457709 | |
| October 7, 2011, | No activity detected | 37.789753, | 0 |
| 1:20 AM | | −122.457709 | |
| . . . | . . . | . . . | . . . |
| October 7, 2011, | No activity detected | 37.789753, | 0 |
| 6:20 AM | | −122.457709 | |

The system examines the data and can make the following observations: the time and date of the entries was during the night on a weekday (e.g., Monday), the duration between the first and last entry is 5 hours 20 minutes, and that the location corresponds to a residential area. The system can compare the collected data with data collected for another corresponding time period (e.g., another Monday night). If the comparison shows a similar pattern, based on these observations, the system can associate or tag the pattern with the context “HOME.”

Another example of pattern matching is to search the log data for groups of consecutive entries where movement is detected. Table C below shows a subset of consecutive entries from Table A where movement was detected.

TABLE C

| | | | |
|---|---|---|---|
| October 7, 2011, | Movement detected | 37.7911186, | 20 |
| 6:30 AM | | −122.4011706 | |
| . . . | . . . | . . . | . . . |
| October 7, 2011, | Movement detected | 37.790358, | 22 |
| 6:40 AM | | −122.3992305 | |

As discussed above, the collected data can be compared with data collected for another corresponding time period to identify patterns. The comparison may indicate, for example, that travel started from about the same location, travel ended at about the same location, the route traveled was about the same, the speed of travel was about the same, or combinations of these. The system may further observe that the ending or destination location corresponds to a commercial building, the speed and distance of travel likely indicates travel not by foot, and other observations. Based on the comparisons and observations, the system may tag the pattern with the context “COMMUTE-TO-WORK.”

The system can apply the pattern matching technique discussed above to the remaining entries in Table A to identify an “AT-WORK” and “COMMUTE-HOME” context and expected device usage and non-usage during each context. In a specific implementation, the usage model includes a set of context situations. Each context situation includes a first time indicating when a context situation is expected to begin, a second time indicating when the context situation is expected to end, a location of the context, information indicating whether the context is expected to fall on a weekday or weekend, expected speed of travel during the context, expected device usage during the context, or combinations of these. Device usage during a particular context may include, for example, an identification of applications used, duration of application usage, calls placed, calls received, duration of call, text messages sent, text messages received, text message size, and so forth.

In a step 1920, the system monitors mobile device activities. The monitoring can include, for example, tracking the location and movement of the device, applications running on the device (e.g., time when application was started, or duration of application use), the level of battery charge in the device, phone calls (e.g., time a phone call was placed, time a phone call was received, or duration of phone call), network activity (e.g., time when a network connection was established, or duration of the network connection)—just to name a few examples.

In a step 1925, the system compares the monitored activities with the contextual usage model (step 1915) to determine any deviations between the model and the activities. In a specific implementation, the comparison includes using the monitored activities to determine a current context of the mobile device, identifying from the usage model expected usage of a resource during the current context, and comparing the expected usage of the resource with actual usage of the resource. For example, the monitored activities may include information indicating that the user is traveling along a particular route. The system can use the collected information to match or identify the current context of the mobile device as being “COMMUTE-TO-WORK.” The usage model can specify the expected usage of the resource (e.g., battery) during the “COMMUTE-TO-WORK” context. The expected usage of the resource (or battery) is compared to the actual usage of the resource to determine deviations between expected and actual use.

In a step 1930, based on the deviations, a prediction is made about the resource to determine whether an amount of the resource will be available for a context following the current context as specified by the contextual usage model. The following context may or may not be an immediately following context. For example, a usage model may include a set of contexts that are chronologically arranged as: “AT-HOME,” “COMMUTE-TO-WORK,” “AT-WORK,” “COMMUTE-TO-HOME,” and “AT-HOME-AFTER-WORK.” If the current context is “AT-WORK,” a context after or following the current context can be “COMMUTE-TO-HOME,” or “AT-HOME-AFTER-WORK.”

If the prediction indicates the resource amount will not be sufficient for the following context, the system reduces use of the resource (step 1935). If the prediction indicates the resource amount will be sufficient for the following context, the system does not reduce use of the resource (step 1940).

More particularly, a deviation may indicate that actual usage of the resource is higher than expected. The user may have made several unexpected phone calls during the current context. For example, the “COMMUTE-TO-WORK” context may have information indicating that no phone calls are expected during the context.

On this particular occasion, however, the user may have made a number of phone calls while commuting to work. These unexpected phone calls may have consumed an amount of battery charge such that the charge level will be insufficient to support the activities during the following context (e.g., “AT-WORK”). So, the system can reduce resource usage (step 1935) so that the resource will be available for the “AT-WORK” activities. In a specific implementation, reducing usage of the resource (e.g., battery) is by activating one or more resource reduction policies that specify actions to take on the device in order to conserve the resource.

Alternatively, a deviation may indicate that actual usage of the resource is lower than expected. For example, the model may specify that during the current context (e.g., “COMMUTE-TO-WORK”) the user is expected to use a particular application.

On this particular occasion, however, the user may not have used the application. So, the amount of battery charged that was expected to be consumed through use of the application will not have been consumed. Thus, there may be a surplus. Usage of the resource will not have to be reduced (step 1940).

When there is a surplus, a policy may be activated that increases usage of the resource. For example, a service that may have been disabled, such as a non-priority or non-essential location service, may be enabled so that the user can enjoy the benefits of the location service with the assurance that the battery charge-level will be sufficient to support the activities of the following context (e.g., “AT-WORK”). Activating device features when there is a surplus of battery power lets the user enjoy the full potential of the device.

For example, message notification frequency may be initially set at a long duration in order to conserve battery power. When there is a surplus, however, the notification frequency can be set to a shorter duration so that the notifications are more up-to-date. As another example, GPS tracking may initially be disabled in order to conserve battery power. If, however, there is a surplus, GPS tracking may be enabled so that the user receives the benefits of location-based services.

As shown by loops 1945 and 1950, the system can continuously monitor activities, make estimates and re-estimates, compare the actual resource usage with the expected resource usage of the context, and make resource adjustments as needed so that the resource will be available for the following context as specified by the contextual usage model.

In a specific implementation, a system provides for the use of the ontology and ontology related processing of low level data into high-level data, and the specification of policy templates based on these abstracted conceptual context situations and behaviors. The construction of context situations can be from observations made from collection of data; e.g., the USING-EMAIL-APP-WHILE-COMMUTING-TO-WORK-FROM-HOME-VIA-BART example.

In a specific implementation, a system provides for the discovery and creation of context behaviors (sequences of context situations) from observed data and the automatic labeling of context situations and behaviors. As discussed above, in a specific implementation, context-awareness is used to intelligently manage the mobile device battery. In another specific implementation, context-awareness is used to adapt the mobile device to a current context. Based on the current context, the home page screen of the device may display some icons, but hide or not display other icons. For example, if the current context happens to be “AT-WORK,” the home screen may not display mobile applications related to games, but may instead display applications related to business productivity. This can help reduce the appearance of clutter on the home screen.

In a specific implementation, a method includes displaying on a home screen of a mobile device a first set of application icons when the mobile device is in a first context, detecting that the mobile device is currently in a second context, different from the first context, and upon the detecting, displaying on the home screen a second set of application icons, different from the first set of application icons. The first set of application icons may belong to a first category of mobile applications (e.g., games or entertainment). The second set of application icons may belong to a second category of mobile applications (e.g., business productivity). A number of application icons in the first set may be different or the same as a number of application icons in the second set. For example, the user may have installed more games as compared to business productivity applications.

As another example, when the user is at the theater, the mobile device may automatically be configured to vibrate so as to not disturb other theater patrons when the user receives a call. In another specific implementation, a method includes permitting an option of the mobile device to remain at a first setting while the mobile device is in a first context, detecting that the mobile device is currently in a second context, different from the first context, and up on the detecting, changing the option to a second setting, different from the first setting. The option may be, for example, a ringer. The first setting may to enable ringing, and the second setting may be to enable vibration. The first context may be “COMMUTE.” The second context may be “THEATER.”

In a specific implementation, modification of resource-usage policies can be by administrators, parents, etc. A “reserve” in resource usage may be provided to allow the completion of a certain number of activities of certain types, e.g., “can make at least one phone call of 3 minutes duration”).

In a specific implementation, the system uses information about the structural relationship amongst different resources to optimize or improve resource usage; e.g., CPU processor activity consumes a certain amount of battery power; thus a policy template goal to reduce battery usage can accomplish this by choosing a policy action which reduces CPU processor activity (which, by the modeled or discovered (via data mining) structural relationship between CPU processor activity and battery power consumption, will therefore reduce battery power consumption).

In a specific implementation, the system provides for the use of an external context-enhancement service to obtain additional information which can be used to select appropriate policy templates for activation; ref., e.g., the example of using a context enhancement service to take GPS coordinates and obtain information about the geophysical location that this is a particular movie theater, which in the ontology is modeled as a conceptual MOVIE-THEATER which inherits properties from parent concept node PERFORMANCE-VENUE, which may have associated with it a set of policy templates which can be activated when the user's current context is a PERFORMANCE-VENUE (e.g., turn phone ringer from ring to vibrate, turn off WiFi and GPS services).

In a specific implementation, a system provides for the use of {context-situation discovery, context-behavior discovery} and data mining based frequency analysis to surface/discover frequently occurring contexts for which an administrator can author policy templates and attach them to those particular contexts.

In a specific implementation, a system provides mined context situations and context behaviors to third parties, for their use in, e.g., modeling typical user workloads on devices in typical situations, for the purposes of optimizing or improving the design of device features and applications. For example, the system can make context situations available through an API or software development kit (SDK).

In a specific implementation, a system provides for the usage of planned future events (e.g., from a user's calendar) to inform the resource prediction method about (a) likely future resource usage, and (b) opportunities for resource reduction during such events, and (c) anomalous extensions to the usual context behaviors (e.g., user has concert tickets tonight at 8 pm and thus won't be at home where a battery charger is even though that's the normal context behavior for this user).

In a specific implementation, a system provides for context behavior adaptation via prefetch (e.g., the music player example), context behavior adaptation via postfetch (as per example discussed above), and context behavior adaptation via substitution (see the example above of arranging VoIP switchover for voice calls).

In a specific implementation, a system provides for use of knowledge about which device a user is currently attending (paying attention to) to drive decisions about which resource conservation actions may be acceptable. In a specific implementation, a system provides for serving ads based on context situations and context behaviors, including the anonymity of ad matching, the auction for ad matching to contexts, etc. In a specific implementation, a system provides for optimizing or prioritizing the choice of what set of active policy templates can be used to achieve a particular goal. In a specific implementation, a system provides for privacy preservation regarding the use and dissemination of context information.

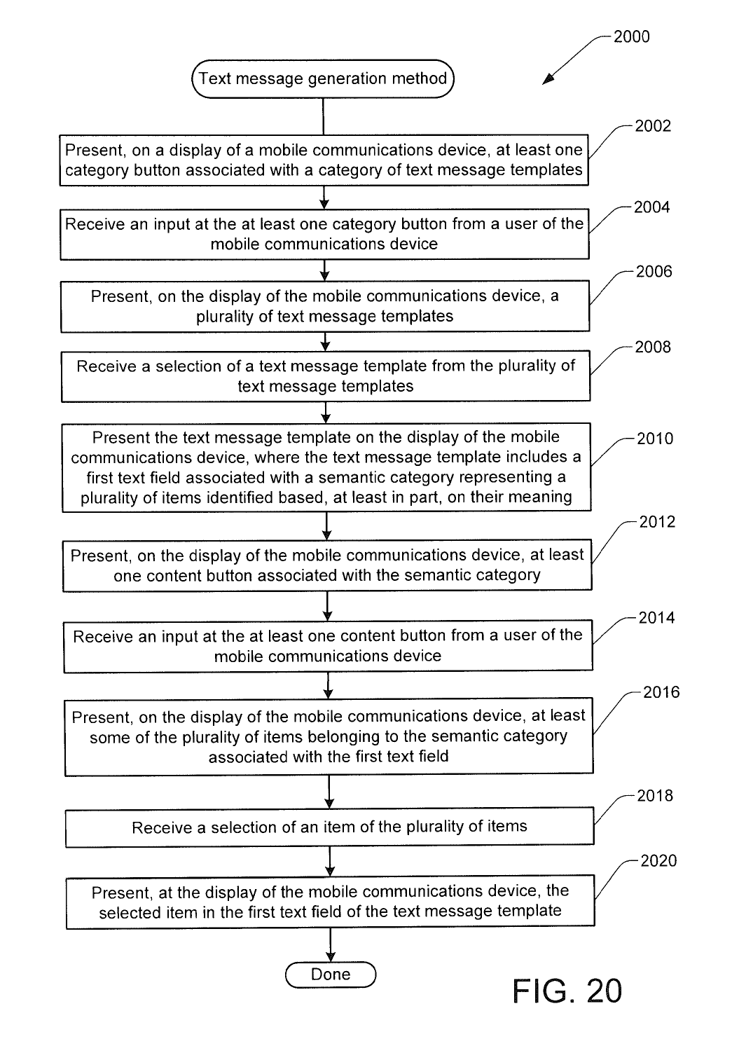

As previously discussed with reference to FIG. 12, text message templates may be generated for the secure composition of text messages. FIG. 20 illustrates an example of a method for generating a text message, in accordance with some embodiments. Text message generation method 2000 may allow a user to generate or compose a text message based on text message templates that have been previously generated, and based on retrieved context information. Thus, the user may automatically be provided with information that may be hard to type and that may be relevant to the user's context.

Accordingly, at step 2002, at least one category button may be presented on a display of a mobile communications device. In some implementations, the display of the mobile communications device may include a display window that presents a user with a user interface for an application that provides text messaging services. The user interface may include components used to send and receive text messages, such as a keyboard, a text entry window, and a display window. The text message template generator may be a separate application that is configured to interact with the application that provides text message services. Thus, the text message template generator may modify the user interface and cause the display of one or more buttons in the user interface. The category button may be a user interface component that is associated with a category of text message templates. As previously discussed, text message templates may be sorted into lists or categories when they are initially generated by the text message template generator. Thus, the category button may be a user interface component that is configured to receive an input from a user, and further configured to cause the display of one or more text message templates for its associated category in response to receiving the input.

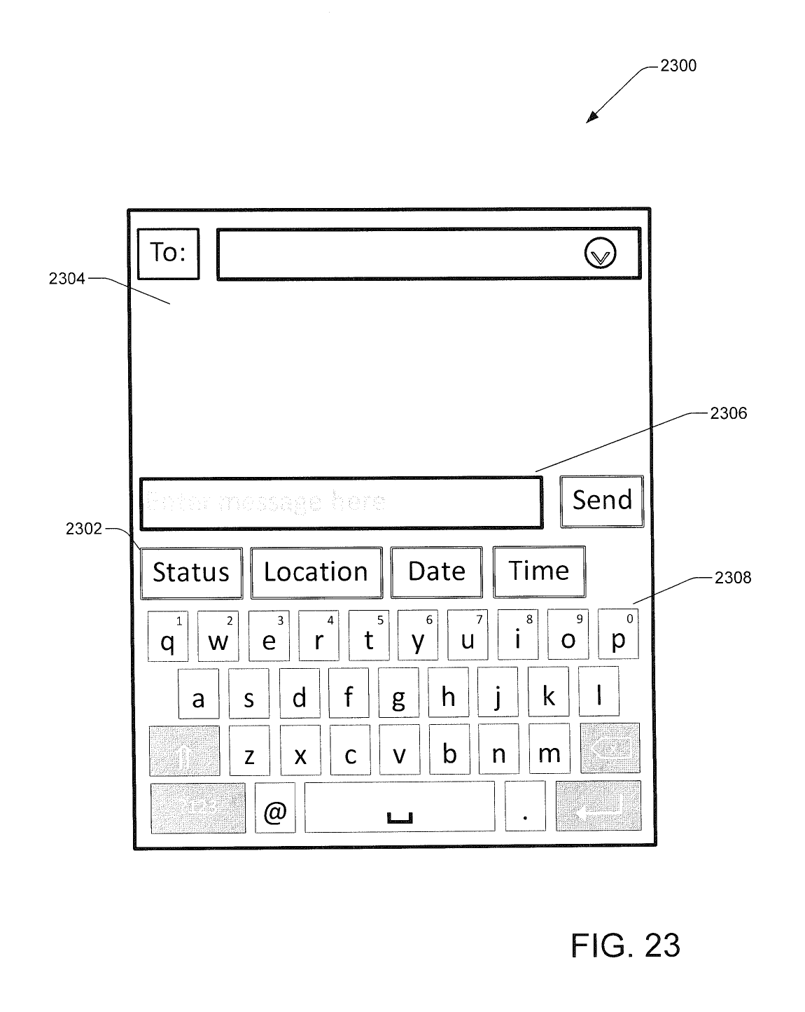

FIG. 23 shows an example of an image of a user interface that may be used to compose text messages, in accordance with some embodiments. Image 2300 includes various user interface components that may be used to compose a text message on a mobile communications device. For example, keyboard 2308 may be used to receive key strokes that provide text input from a user. Text field 2306 provides a text field in which text may be entered when composing a text message. Display window 2304 may display previous text messages that have been sent in a particular conversation. Image 2300 may also include a category button, such as status button 2302, which may be generated and provided by a text message template generator.

Returning to FIG. 20, at step 2004, an input may be received at the at least one category button from a user of the mobile communications device. Thus, a user may initiate the composition of a text message by providing an input to a category button. For example, a user may provide an input, such as touching a touch screen or selecting with a cursor, to a status button to begin composing a text message related to the user's current status.

At step 2006, a plurality of text message templates may be presented on the display of the mobile communications device. Thus, in response to receiving an input from a user at a category button, several text message templates may be presented to the user. In some implementations, the text message templates are provided by the text message template generator. Thus, the text message templates may be several templates generated based on messages previously sent by the user and related to the category associated with the category button that was selected.

As similarly discussed with reference to FIG. 12, the presentation of the list of text message templates may be determined and modified by the text message template generator. In some implementations, the modification may occur dynamically and automatically based on the user's current context. For example, if a text message template has not been used for a predetermined amount of time, then the text message template may be given a lower priority position in the list of text message templates that is presented at the display of the mobile communications device. Alternatively, the text message template may be removed from the list of text message templates presented to the user.

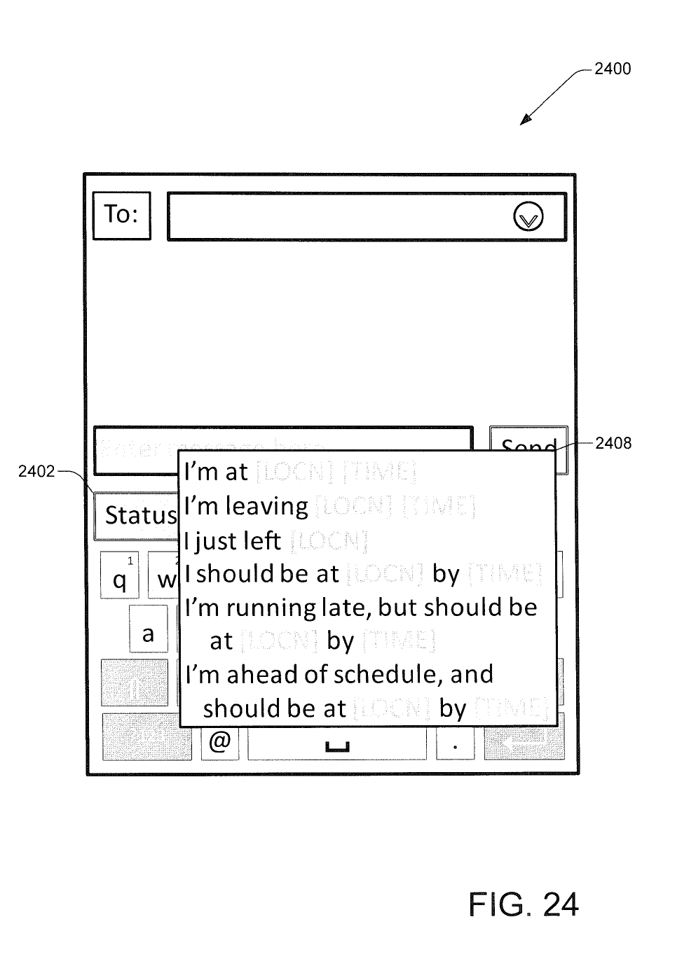

FIG. 24 shows an example of an image of a user interface presenting several text message templates to a user at a display of a mobile communications device, in accordance with some embodiments. Image 2400 includes status button 2402, which has been selected by a user and received an input from the user indicating that the selection has been made. In response to receiving the selection, data field 2408 has been displayed. Data field 2408 may be a data field capable of displaying one or more text message templates included in the category associated with status button 2402. Thus, data field 2408 displays several text message templates related to the user's status. Each text message template includes a portion of text that is automatically generated. Each text message template also includes at least one text field associated with at least one semantic category. In this instance, several of the text message templates include text fields for the semantic category “location” and for the semantic category “time”.

Returning to FIG. 20, at step 2008, a selection of a text message template may be received. Thus, a user may select one of the presented text message templates that will form the basis of the text message that the user is composing. Referring again to FIG. 24, the selected text message template may be identified in data field 2408 by shading, highlighting, or any other appropriate form of identification. In this instance, the user has selected a text message template that includes the text “I just left [LOCN]”. Thus, the portion of data field 2408 displaying the text message template “I just left [LOCN]” has been shaded.

Returning to FIG. 20, at step 2010, the selected text message template may be presented in the display of the mobile communications device. Furthermore, the text message template may be entered into a text entry window of the user interface. As previously discussed, the user interface presented at the mobile communications device may include a text entry window in which a user typically enters, via a keyboard, text to be included in a text message. In some implementations, the text message template generator may be configured to insert text and text message templates into the text entry window. Thus, the application that provides text messaging services may receive the text via the text entry window and process it as it would for text entered by a user. Accordingly, in response to receiving the user's selection, the text message template that was selected by the user may automatically be entered into a text entry window configured to receive text included in a text message.

At step 2012, at least one content button may be presented on the display of the mobile communications device. As previously discussed, the text message template may include a first text field associated with a semantic category. For example, the selected text message template may include a text field associated with the semantic category LOCATION and identified by the data value “[LOCN]”. A content button associated with the semantic category LOCATION may be presented in the display of the mobile communications device. In some embodiments, the content button may be presented at the same time the category button is presented. Alternatively, the content button may be displayed in response to a text message template being selected. The content button may be a user interface component corresponding to the text field included in the text message template. The content button may be configured to cause the display several items belonging to the semantic category associated with the text field in response to receiving an input from a user. Thus, the content button may provide a user with the ability to populate contents of a text field based on items belonging to its associated semantic category.

In some implementations, the content button may be user defined. Thus, a user may specify a relationship between a custom content button and a text field included in a text message template. If a text message template including a text field associated with the custom content button is selected, the custom content button may be presented in the user interface.

As set forth above, the content button may be presented in response to the text message template being selected. Thus, the content button may be visible in the user interface when a text message template that references that content type is active in a text entry window of the user interface. For example, a user could define a content type of RESTAURANT, but could specify that the user interface does not present a “Restaurant” button unless a text message template has been selected that that includes the text field “[RESTAURANT]”. In an embodiment, a user may type a semantic category placeholder directly into a text entry window to insert a data field into a text message that is being composed. For example, the user may type the text “[RESTAURANT]” into the text entry window, which would trigger the user interface to present a “Restaurant” content type button configured to cause the presentation of several items from the semantic category RESTAURANT that the user may select from.

At step 2014, an input may be received at the at least one content button from a user of the mobile communications device. Thus, a user may decide that text fields of the text message template should be filled to complete at least a portion of the text message that is being composed. Returning to a previous example, the text message template may include the text “I just left [LOCN]” and a content button associated with the semantic category LOCATION may be presented in the user interface. A user may decide to fill out the text field “[LOCN]” and provide an input to its associated content button.

At step 2016, at least some of a plurality of items belonging to the semantic category associated with the first text field may be presented in the display of the mobile communications device. Thus, in response to receiving the input from the user, the content button may cause the presentation of several items belonging to the semantic category associated with the text field. Returning to the previous example, if the content button associated with the text field “[LOCN]” receives an input, several items belonging to the semantic category LOCATION may be displayed in the user interface.

In some implementations, the items that are presented are selected dynamically and automatically from information that may have been previously retrieved. The previously retrieved information may include previously retrieved context information. In some implementations, the items that are displayed may be determined and modified by the text message template generator or a context management service. Thus, the text message template generator may present the items in the user interface as an ordered list. The order of items in the list may be pre-determined, or may be determined based on events that occurred recently, are occurring now, or are expected to occur in the future. For example, a list of locations that the user has recently visited, or the location where the user currently is could be used to populate the LOCATION list or assign priority or position to items included in the LOCATION list. Items from the user's calendar may have locations associated with them. Locations from appointments that occurred in the past, are occurring now, or are planned for the future can be used to populate or assign priority or position to the list of items for the LOCATION list.

Furthermore, items in a list for a particular text field may be populated based on current context situations or behaviors. For example, a text field associated with a semantic category of WEATHER may have an associated list of items that is populated based on weather conditions that occurred recently at the user's recent, current, or planned locations. The list may also be populated based on current weather conditions that pertain to these locations, or predicted weather conditions that pertain to these locations.

In some implementations, the items that are presented may be determined based on inputs received at other content buttons. For example, a text message template might include the text, “It's supposed to [WEATHER] at [(LOCATION, TIME)], so my flight may be late.” Items presented in a list for the text field “[WEATHER]” may depend upon the values that have been chosen using content buttons associated with “LOCATION” and “TIME”. In this example, pressing a “Location” button and choosing a value, then pressing a “Time” button and choosing a value, may determine which items are included in the list of items presented when the “Weather” button is pressed, or may automatically populate the contents of the text field “[WEATHER]”. For example, weather conditions for the chosen location at the chosen time may have higher priority on the list of items presented to the user, or may automatically provide text that is substituted for the text field “[WEATHER]”.

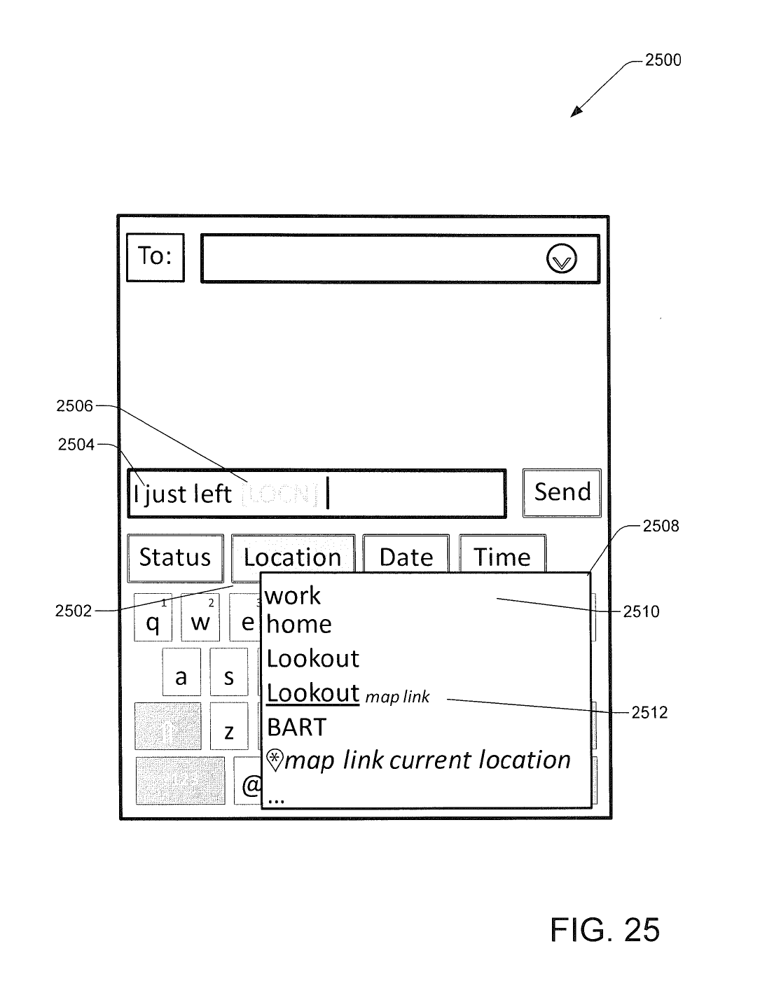

FIG. 25 shows an example of an image of a user interface presenting several items belonging to a semantic category at a display of a mobile communications device, in accordance with some embodiments. Image 2500 shows a user interface that contains a text entry window that includes text message template 2504. In this example, text message template 2504 includes text field 2506, which is associated with the semantic category LOCATION. The user interface also includes content button 2502, which is associated with the text field 2506. In response to being selected, content button 2502 displays several items belonging to the semantic category associated with text field 2506. In this example, content button 2502 has caused the display of several items in data field 2508 that belong to the semantic category LOCATION. As previously discussed, the order and presentation of the items displayed in data field 2508 may be determined dynamically and based on the user's current context. Furthermore, the items displayed may be of varying data types. For example, some items are text, while others, such as item 2512, are links to other data objects, such as a map of a geographical location. In this example, item 2512 provides a link to a map of the geographical location of Lookout®.

Returning to FIG. 20, at step 2018, a selection of an item of the plurality of items may be received. Thus, a user may select one of the presented items that will be inserted in a text field of the selected text message template. Referring again to FIG. 25, the selected item may be identified in data field 2508 by shading, highlighting, or any other appropriate form of identification. In this instance, the user has selected an item that includes the text “work”. Thus, portion 2510 of data field 2508 displaying the text “work” has been shaded.

Returning to FIG. 20, at step 2020, the text message template may be presented at the display of the mobile communications device, where the first text field of the text message template includes the selected item. Thus, the text field that was originally included in the selected text message template may be replaced by the item selected at step 2018. For example, if the selected text message template included the text “I just left [LOCN]”, a selected item of “work” may replace the text field “[LOCN]”. The text included in the text entry window may now be “I just left work.” Thus, the text fields of the text message template may be filled in to create a complete string of text that may be sent as a text message.

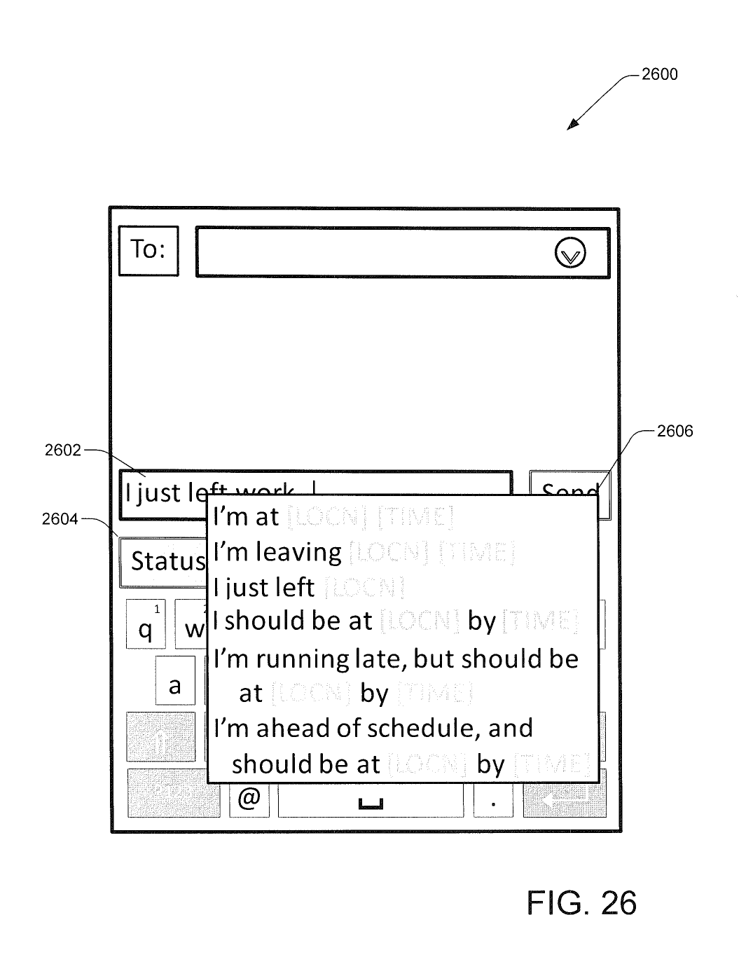

In various implementations, text message generation method 2000 may be repeated as many times as desired to generate a text message. Therefore, the previously described method may be used iteratively to fill out multiple sentences in a single text message. FIGS. 26-29 illustrate a series of images of user interface screens in which a second iteration of text message generation method 2000 may be performed. Accordingly, FIG. 26 shows an example of an image of a user interface in which a second iteration of a text message generation method is being performed, in accordance with some embodiments. Image 2600 includes a string of text, such as sentence 2602, generated by a previous iteration of the text message generation method. In this example, the sentence is “I just left work.” Image 2600 also includes a category button, such as status button 2604. In this example, status button 2604 has received an input and has caused the display of several text message templates in data field 2606 that are related to the user's status.

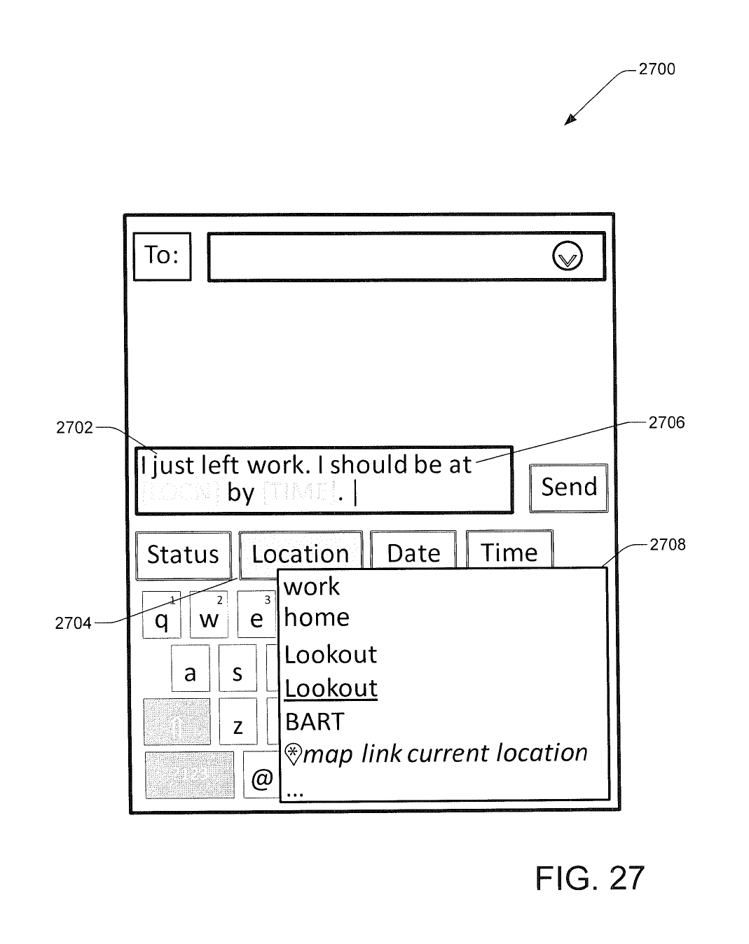

FIG. 27 shows an example of an image of a user interface in which a second text message template has been chosen and a first content button has been selected for a first text field, in accordance with some embodiments. Image 2700 includes text entry window 2702 which includes text message template 2706 in response a user selecting text message template 2706. Image 2700 also includes category button 2704 which is associated with the text field “[LOCN]” included in text message template 2706. In some embodiments, category button 2704 is displayed in response to the selection of text message template 2706. In this example, after being displayed, category button 2704 has received an input from a user that causes the display of several items in data field 2708. The displayed items belong to the semantic category associated with the text field “[LOON]”. As indicated by the shaded portion of data field 2408, the user has selected the item “home”.

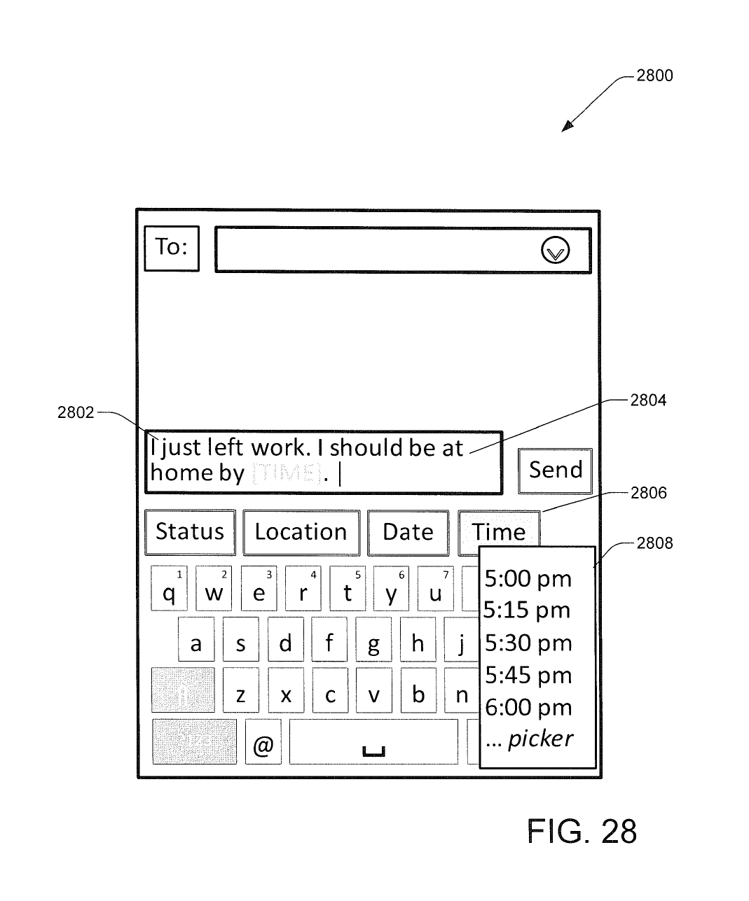

FIG. 28 shows an example of an image of a user interface in which a second content button has been selected for a second text field, in accordance with some embodiments. As similarly discussed above, image 2800 contains a text entry window that includes a selected text message template. In this instance, the text entry window includes text message template 2802 which was generated and completed in a previous iteration of the text message generation method. The text entry window also includes text message template 2804, which now includes the selected item “home” instead of a first text field. In this example, content button 2806 has been selected for a second text field included in text message template 2804. In response to being selected, content button 2806 causes the display of several items belonging to the semantic category associated with the text field “[TIME]”. The items may be selected based on contextual information, such as the current time at the user's current location. In this example, a user has selected the time “5:15 pm”. Thus, the item “5:15 pm” may replace the text field “[TIME]” in text message template 2804.

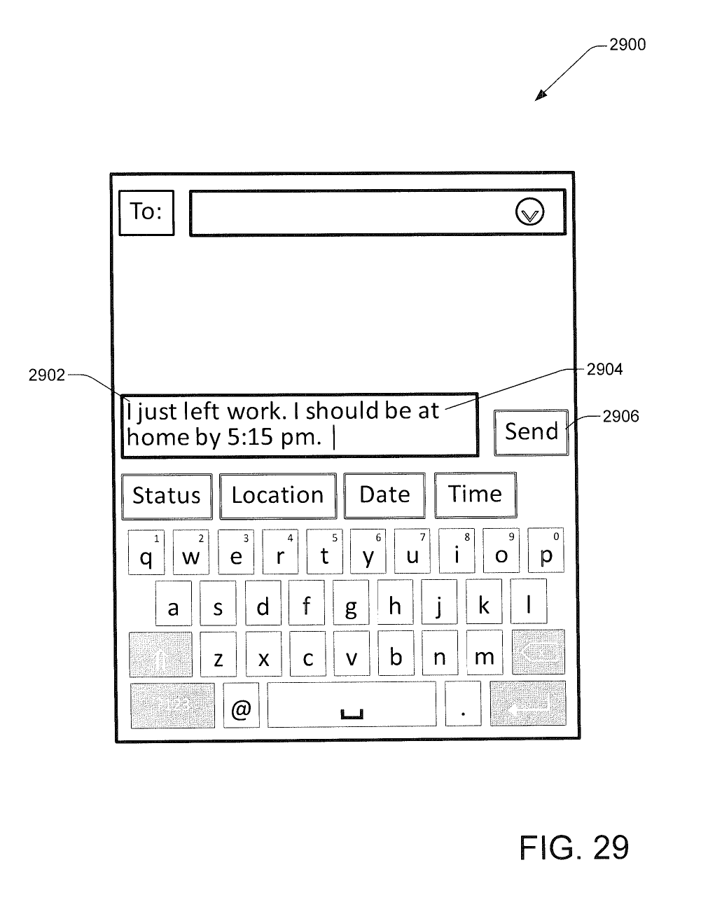

FIG. 29 shows an example of an image of a user interface in which a text entry window includes multiple text message templates have been generated and completed, in accordance with some embodiments. As similarly discussed above, image 2900 includes a text entry window. In this example, the text entry window includes text message template 2902 and text message template 2904, which have been generated and completed using two different iterations of the text message generation method. A user may provide an input to button 2906 to send the composed text message to a recipient.

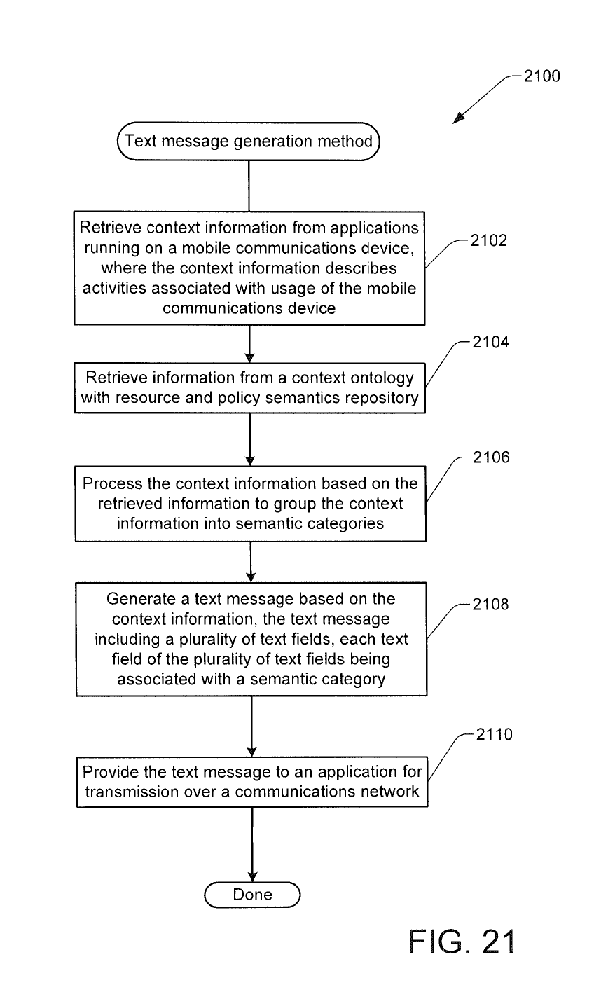

FIG. 21 illustrates an example of a method for generating a text message in which the text message template generator and the context management service are included in the same application on a mobile device, in accordance with some embodiments. Thus, the text message template generator and context management service may be part of a single secure text message composition application that retrieves context information, processes it, and generates secure text messages based on the processed context information.

Accordingly, at step 2102 context information may be retrieved from applications running on the mobile communications device. As similarly discussed with reference to FIG. 12, several applications may be running on the mobile communications device and may collect information from various sources. For example, one application may collect physical metrics from a sensor, such as an accelerometer, while another application may collect metadata from email messages sent by the user. Thus, each application may be collecting and storing information as part of their respective normal operations.

In some embodiments, the applications from which context information is retrieved may have been previously registered as semantic category providers. The registration process may have been part of a configuration process that occurs upon initial setup of the secure text message composition application. The registration process may also occur at some later point in time at which a list of semantic category providers is updated or modified. Once registered as semantic category providers, each application has an associated event listener which may be implemented as part of the operating system running on the mobile communications device. The event listeners may listen for an event, such as a request that may be issued by the secure text message composition application. The request may be broadcast to all event listeners. In response to detecting the request, each event listener may send a notification to its associated application. Upon receiving the notification, each application may package the context information that it has collected into a data object and send the data object to the operating system, which then forwards the data object to the secure text message composition application. As previously discussed, each application may sort, rank, process, or otherwise modify the context information prior to packaging and sending it. Alternatively, one or more applications may return raw data that has not been processed.

At step 2104, information may be retrieved from a Context Ontology with Resource and Policy Semantics (CORPS) repository. Thus, rules, policies, and one or more ontologies may be retrieved to process the information that was retrieved at step 2102. Because the CORPS may be included in the secure text message composition application, the retrieval process may comprise a component, such as a context manager, querying a data store used by the CORPS. As previously discussed, the CORPS may include information which may be used to map individual pieces of information or data to broader and more abstract semantic categories. Thus, upon completion of step 2104, the secure text message composition application may have sufficient information to sort or group the retrieved context information into semantic categories.

Accordingly, at step 2106, the context information may be processed based on the information retrieved from the CORPS. Thus, each item of the retrieved context information may be processed and assigned to one or more semantic categories. The processed items may be stored for future use when a text message is to be composed. In some embodiments, the processed items may be stored in separate data tables based on their respective semantic categories. Alternatively, the processed items may be stored in the same data table, but each item may be stored with one or more identifiers that identify which semantic categories that item belongs to.

At step 2108, a text message may be generated based on the context information. The text message may be generated in accordance with a text message generation method similar to that described with reference to FIG. 20. Thus, a text message template may be displayed on a display of the mobile communications device. The text message template may include text fields that are filled out based on the processed context information to create a complete text message that efficiently and accurately conveys the user's message.

At step 2110, the text message may be transmitted from the mobile communications device. Thus, once the text message has been composed, the mobile communications device may transmit the text message to its intended recipient via a communications network.

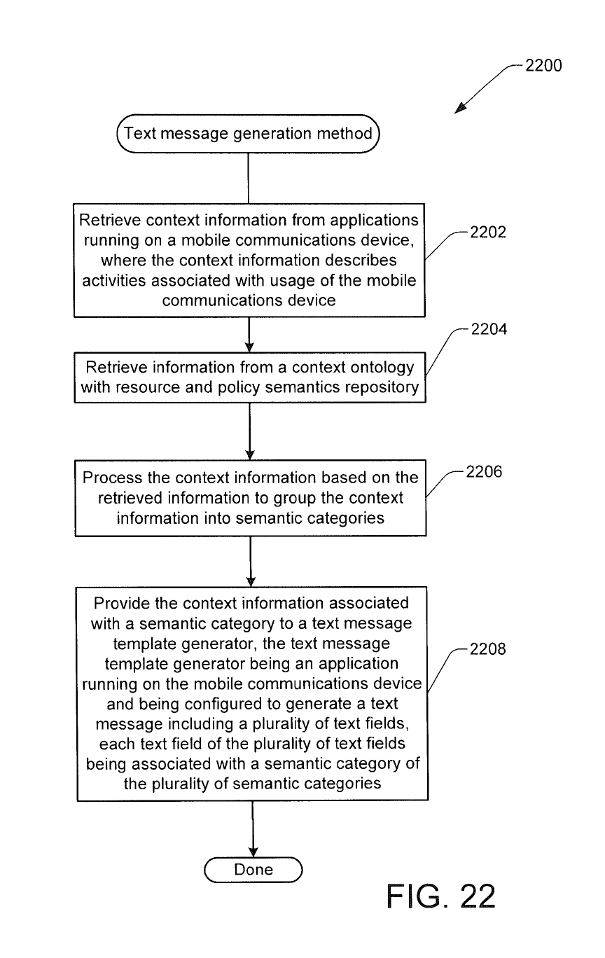

FIG. 22 illustrates an example of a method for generating a text message in which the text message template generator and the context management service are included in different applications on a mobile device, in accordance with some embodiments. Thus, the context management service and the text message template generator may be implemented in separate applications and use an intermediary to communicate with each other when retrieving context information, processing the context information, and generating secure text messages.

Accordingly, at step 2202 context information may be retrieved from applications running on the mobile communications device. As set forth above with reference to FIG. 21, several applications may be running on the mobile communications device and may be registered as semantic category providers. Thus, each of the applications may have one or more associated event listeners that listen for a request. In some embodiments, the context management service may be configured to issue a request and retrieve context information from the various different applications that are semantic category providers. According to various embodiments, the text message template generator may also be configured to issue a request and retrieve context information from the semantic category providers. Thus, either one of or both of the text message template generator and the context management service may be configured to broadcast requests for context information.

At step 2204 information may be retrieved from a Context Ontology with Resource and Policy Semantics (CORPS) repository. As set forth above with reference to FIG. 21, the CORPS may store information that may be used to sort and group the retrieved context information into semantic categories. Thus, a component, such as a context manager, may query a data store used by the CORPS and retrieve the relevant information.

At step 2206, the context information may be processed based on the information retrieved from the CORPS. Accordingly, each item of the retrieved information may be processed and assigned to one or more semantic categories by one or more components of the context management service. The processed items may be stored for future use when a text message is to be composed.

At step 2208, the context information may be provided to the text message template generator. In some embodiments, the context management service application automatically provides the processed context information to the text message template generator once it has completed processing the context information. In various embodiments, the context management service application provides the processed context information to the text message template generator in response to receiving a request from the text message template generator. For example, the text message template generator may issue a request for the processed context information when it is in the process of composing a text message. The text message template generator and context management service may communicate with each other through a broadcast/listener process in which the context management service provides the processed context information to the text message template generator in response to detecting a broadcast request issued by the text message template generator. Alternatively, the text message template generator and context management service may communicate with each other via a separate dedicated application program interface (API).

The text message template generator may receive the processed context information and use it to generate a text message in accordance with a method as set forth above with reference to FIG. 20. The completed text message may subsequently be sent from the mobile communications device to its intended recipient via a communications network.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. A method of generating a text message on a mobile communications device, the method comprising:
on a mobile communications device, presenting a text message template on a display of the mobile communications device, the text message template including a first text field associated with a semantic category representing a plurality of items identified based, at least in part, on their meaning;
presenting, on the display of the mobile communications device, at least one button associated with the semantic category;
receiving, at the at least one button, an input from a user of the mobile communications device;
presenting, on the display of the mobile communications device, at least some of the plurality of items belonging to the semantic category associated with the first text field, the presenting being responsive to receiving the input;
receiving a selection of an item of the plurality of items; and
presenting, at the display of the mobile communications device, the selected item in the first text field of the text message template.

2. The method of claim 1 further comprising collecting, on the mobile communications device, context information describing a plurality of activities associated with usage of the mobile communications device.

3. The method of claim 2, wherein the context information is a type of information selected from the group consisting of: a geographical location associated with the user, applications used by the user, time and date information, and a speed associated with the user.

4. The method of claim 2 further comprising selecting the text message template based on the context information.

5. The method of claim 2 further comprising identifying the at least some of the plurality of items based on the context information.

6. The method of claim 2, wherein the plurality of items is presented in an order determined based on the context information.

7. The method of claim 1, wherein the semantic category is selected from the group consisting of: status, location, date, time, and security.

8. The method of claim 1, wherein the text message template is generated by one or more components of the mobile communications device based on a plurality of text messages previously sent by the user.

9. The method of claim 1, wherein the text message template further includes a second text field that is automatically populated by one or more components of the mobile communications device.

10. The method of claim 9, wherein the second text field is automatically populated based on the received selection of the item.

11. The method of claim 1, wherein the text message template is a template for a short message service (SMS) message.

12. The method of claim 1, wherein the text message template relates to a security event on the mobile communications device.

13. A method of generating a text message on a mobile communications device, the method comprising:
on the mobile communications device, retrieving context information from a plurality of applications running on the mobile communications device, the context information describing a plurality of activities associated with usage of the mobile communications device;
processing the context information by grouping the context information into a plurality of semantic categories each representing a plurality of items identified based, at least in part, on their meaning; and
generating a text message based on the context information and a text message template, the text message template including a plurality of text fields, each text field of the plurality of text fields being associated with a semantic category of the plurality of semantic categories.

14. The method of claim 13, wherein the context information is grouped into the plurality of semantic categories based on an ontological semantic analysis of the information retrieved from the plurality of applications running on the mobile communications device.

15. The method of claim 13, wherein the semantic category is selected from the group consisting of: status, location, date, time, and security.

16. The method of claim 13, wherein the context information is a type of information selected from the group consisting of: a geographical location associated with the user, applications used by the user, time and date information, and a speed associated with the User.

17. A method of generating a text message on a mobile communications device, the method comprising:
on the mobile communications device, retrieving context information from a plurality of applications running on the mobile communications device, the context information describing a plurality of activities associated with usage of the mobile communications device;
processing the context information to group the context information according to a plurality of semantic categories each representing a plurality of items identified based, at least in part, on their meaning; and
providing context information associated with a semantic category of the plurality of semantic categories to a text message template generator, the text message template generator being an application running on the mobile communications device and being configured to generate a text message based on the context information and a text message template, the text message template including a plurality of text fields, each text field of the plurality of text fields being associated with a semantic category of the plurality of semantic categories.

18. The method of claim 17, wherein the context information is grouped into the plurality of semantic categories based on an ontological semantic analysis of the information retrieved from the plurality of applications running on the mobile communications device.

19. The method of claim 17, wherein the processing is performed by a context management service that is an application registered with an operating system of the mobile communications device as a semantic content provider, and wherein the context information is provided in response to a request issued by the text message template generator.

20. The method of claim 17, wherein the context information is a type of information selected from the group consisting of: a geographical location associated with the user, applications used by the user, time and date information, and a speed associated with the user.
